(19) United States
(12) Patent Application Publication
(10) Pub. No.: US 2024/0019217 A1
(43) Pub. Date: Jan. 18, 2024

(54) ENERGY STORAGE DEVICE

(71) Applicant: GRAPHITE ENERGY (ASSETS) PTY LIMITED, Surry Hills (AU)

(72) Inventors: Peter LEMMICH, Surry Hills (AU); Paul Soo-Hock Khoo, Surry Hills (AU); Jun Chao, Surry Hills (AU); Byron Ross, Surry Hills (AU); Casey Walsh, Surry Hills (AU)

(21) Appl. No.: 18/358,893

(22) Filed: Jul. 25, 2023

Related U.S. Application Data
(63) Continuation-in-part of application No. 18/272,302, filed on Jan. 1, 0001.

(30) Foreign Application Priority Data
Jan. 29, 2021 (AU) 2021900197

(51) Int. Cl. F28D 20/02

(52) U.S. Cl. CPC F28D 20/025; F28D 20/028; F28D 2020/0008

(57) ABSTRACT

The invention provides an energy storage apparatus comprising: a sensible heat storage body having a heat exchanger channel and a heating element channel adapted to receive a removable heating element; and a heat exchanger having an inlet and an outlet, wherein at least a portion of the heat exchanger is disposed along the channel. Also provided are methods or reversibly storing and/or extracting energy, a heating element and an energy storage array comprising a plurality of energy storage apparatus as described herein.

### CROSS-REFERENCE TO RELATED APPLICATIONS

This application is a continuation-in-part of U.S. patent application Ser. No. 18/272,302 filed Jul. 13, 2023, which is the U.S. national phase entry of International Patent Application No. PCT/AU2022/050031 filed Jan. 25, 2022, which claims priority from Australian Provisional Patent Application No. 2021900197 filed Jan. 29, 2021, the contents of which should be understood to be incorporated by reference in their entireties.

### FIELD OF THE INVENTION

The present invention relates to an energy storage apparatus which can be used for high temperature applications such as generators. In particular, the present invention relates to an energy storage apparatus which can be operated at temperatures such that supercritical fluids can be used for efficient electricity generation using Brayton cycle generators.

In particular, the present invention relates to a graphite-based thermal energy storage apparatus which is safe and easy to maintain for an end user and is suitable for use with Brayton cycle generators and a method for storing thermal energy. However, it will be appreciated that the invention is not limited to these particular fields of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of the common general knowledge in the field.

Global energy consumption continues to increase year on year to meet demand. While there are many sources of energy such as coal, natural gas, nuclear and oil, coal continues to be one of the major sources for electricity energy production. However, use of coal-fired power stations is highly polluting and releases harmful greenhouse gases. The development of renewal energy technologies has been of particular interest due to environmental concerns (such as reducing pollution and carbon dioxide emissions from coal and other fossil fuels). These renewal energy technologies include hydro, wind, solar, tidal and geothermal heat.

A particular issue of energy production from renewable energy sources is that they are intermittent sources. For example, wind turbines require strong winds, solar power cannot be generated at night, hydro power generation is reduced severely during drought, and wave power is limited according to weather and sea conditions. As such, renewable technologies ideally require a method of storing the energy for later use.

One such approach to storing energy is to use battery technology such as lithium-ion batteries so that when on-demand production of electricity from a renewable source is unavailable, the energy demand can readily be met. However, battery technology can still be expensive for large-scale deployment and the energy capacity stored is limited and may not meet the energy demands when renewable energy production is delayed for long periods (such as when there are consecutive cloudy days for solar energy production, etc.).

As an alternative to battery technology, sensible heat storage mediums have been used to store thermal energy. For example, graphite energy storage mediums have been used to store electrical energy generated from sources such as renewables in the form of heat. A variant of the above approach is heating a body of graphite induced by eddy currents. The thermal energy stored in a block of graphite can then be recovered for later use and converted into electrical energy using a fluid such as steam.

The energy storage apparatus of WO 2005/088218 describes a method of and an apparatus for storing heat energy in a body of graphite. The method comprises heating an inner region of a body of graphite when it is required to store the heat energy and recovering the heat by way of a heat exchanger, when the energy is required to be used. The heating of the inner region of a body of graphite in WO 2005/088218 is achieved by embedding a non-removable resistor within the graphite body. The resistor constitutes a mixture of granular graphite or carbon and with or without ceramic granules. The resistor is connected to electrodes which are also at least partially embedded in each bore or well and are non-removable. When the electrode is in electrical communication with a power supply and the resistor, the embedded resistor heats the inner region of the graphite body due to electrical resistance. The resistor described is an open resistor which can be prone to overheating issues which reduces operating life.

A further iteration of graphite solar storage technology relates to a thermal energy storage module as described in WO 2015/085357 comprising a plurality of spaced thermal energy storage panels, where each panel is separated by heater assemblies. Each thermal energy storage panel comprises a graphite core, a substantially gas tight housing encasing the graphite core, and a heat exchanger comprising heat exchanger tubing. The heater assemblies are external to the spaced thermal energy storage panels and heat the thermal energy storage panels externally when an electrical connection is established between the heater assemblies and a supply of electrical power. The heater assemblies described have a low watt density (about 3 to 5 W/in²) due to the low thermal conductivity and low specific heat of the surrounding gas. The low watt density of the heater assemblies is required to prevent or reduce overheating of the heater assemblies to avoid premature failure. Further, the heat transfer mechanism from the heaters is via radiation to the substantially gas tight housing, then conduction from the housing to the graphite core. The housing material has a high emissivity and the heat is re-radiated away from it. Heat loss is proportional to T⁴ (where T is temperature) which amplifies the issue when the skin temperature increases. Another cause for the high heat loss is the difficulty of avoiding hot air leakage paths from the heater cavity. As such, the thermal energy storage module as described in WO 2015/085357 requires a large heating surface area of the heater assemblies which can be expensive to operate.

Given the limitations in the graphite storage technology as discussed above, it may therefore be desirable to develop an alternative energy storage apparatus and a method for storing energy for use in high temperature applications for electricity generation such as sCO₂ Brayton cycle generators and which can be more efficient and easier to maintain for the end user or operator.

It is an object of the present invention to overcome or ameliorate at least one of the disadvantages of the prior art, or to provide a useful alternative.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

Continuous development of energy storage systems has driven the desire to develop alternative energy storage systems particularly for use in high temperature applications such as Brayton cycle generators. In particular, there is a desire to develop alternative energy storage systems which are efficient at storing and/or extracting thermal energy as well as being easy to maintain for long term use in the event that the energy storage apparatus is faulty or damaged.

### Method for Reversibly Storing/Extracting Energy

According to one aspect, the present invention provides a method of reversibly storing and/or extracting energy comprising the steps of: heating an inner region of a sensible heat storage body using a removable heating element thereby storing energy; and extracting energy by flowing a heat transfer medium through an inlet and an outlet of the sensible heat storage body having an inlet temperature below that of said sensible heat storage body such that energy is transferred from the sensible heat storage body to the heat transfer medium having an outlet temperature, thereby providing reversible energy storage and extraction.

Advantageously, the present inventors have developed a method and apparatus as described herein for storing and/or extract energy using a removable heating element. The removable heating element can provide ease of maintenance as the heating element can be removed and repaired or replaced with a new heating element once the heating element has reached end of life or when damaged.

As used herein, the phrase “inner region” refers to internal heating of the sensible heat storage body, for example, heating a surface of the heating element channel located internally of the sensible heat storage body. Heating the inner region of the sensible heat storage body can provide for efficient conduction of the heat from the removable heating element to the sensible heat storage body therefore reducing the number of heating elements required for a given storage temperature and reduction of overall cost.

In certain embodiments, a portion of the heating element is in contact with the inner region of the sensible heat storage body. Preferably, the heating portion of the heating element is in contact with the inner region of the sensible heat storage body. In these embodiments, the heating portion of the heating element is in thermal contact with the inner region of the sensible heat storage body but not electrical contact. Advantageously, when the heating element is in direct contact with the surface of the inner region of the sensible heat storage body during heating, the heating portion of said heating element is able to efficiently heat the body by conduction, rather than relying on heat convection via the surrounding atmosphere or radiation. Typically, heating by conduction is more efficient for transferring thermal energy compared to convection or radiation.

Suitable materials for the sensible heat storage body include but are not limited to silicon carbide, sand, concrete, graphite, reinforced polymer, clay, porcelain, ceramics, carbon nanotubes, aluminium nitride, aluminium oxide, boron nitride, silicon nitride, steel, copper, mullite, zirconium oxide, ductile iron, cast iron, stainless steel, brass, alloys of columbian, tantalum, molybdenum, tungsten and combinations thereof. It should be appreciated the sensible heat storage body materials are not listed exhaustively above, but merely exemplify the types of materials that can be used depending upon the operating parameters selected.

Advantageously, the sensible heat storage body can provide higher operating temperatures such as from about 350° C. to about 1500° C., about 400° C. to about 1000° C., and even more preferably about 850° C. Accordingly, this can take advantage of the efficiency of Brayton cycle generators which typically have the greatest operational efficiency within this temperature range.

At temperatures from about 400° C. to about 1000° C., supercritical fluids such as CO₂ (sCO₂) can be used (wherein no phase change of the heat transfer medium occurs upon heating within this range). This allows for greater efficiencies when the energy storage apparatus is used in conjunction with an electrical generator such as a Brayton cycle generator. However, as will be appreciated, the energy storage apparatus of the present invention can be used with conventional turbines, turbo-expander generators and/or similar.

In a preferred embodiment, the sensible heat storage body is formed of graphite. In some embodiments, the graphite is crystalline, amorphous or a combination thereof. Graphite also has high thermal stability and electrical and thermal conductivity which makes it suitable for use as a refractory in high-temperature applications. In preferred embodiments, the graphite is used between ambient temperature up to 1000° C. and in preferred embodiments, the operational temperature is between about 400 to 850° C. Advantageously, the use of graphite as a sensible heat storage body material is that it can be self-lubricating and also has dry lubricating properties. This provides improved compatibility with different materials of heat exchangers and can provide versatility due to modular construction.

In one embodiment, the sensible heat storage body is formed of silicon carbide. Silicon carbide is composed of a crystal lattice of carbon and silicon atoms, and is able to provide structural integrity to the sensible heat storage body. Silicon carbide is relatively inert in that it does not react with acids, alkali materials, or molten salts at temperatures up to 800° C. Further, silicon carbide forms a silicon oxide coating at 1200° C. which is able to withstand temperatures up to 1600° C. The sensible heat storage body material therefore includes silicon oxide in one embodiment. Silicon carbide also has high thermal conductivity, low thermal expansion characteristics and high mechanical strength, and thus provides the sensible heat storage body with relatively high thermal shock resistance qualities. It should be apparent that a sensible heat storage body made of silicon carbide is resistant to chemical reactions, is suitably strong, and has good thermal conductivity which assists in heating the phase change material.

In some embodiments, the sensible heat storage body has a density between about 1 g/cm³ and about 4 g/cm³, between about 1.5 g/cm³ and about 3.5 g/cm³, between about 2.0 g/cm³ and about 3.5 g/cm³, between about 2.5 g/cm³ and about 3.5 g/cm³, preferably between about 1.5 to 2.0 g/cm³.

In one embodiment, the heat transfer medium is a heat transfer fluid. A heat transfer fluid is a medium (such as a gas, liquid or supercritical gas) which allows passive transfer of energy, typically thermal energy, to another medium or for further conversion to mechanical energy. In this embodiment, the heat transfer fluid is used to extract or transfer heat from the sensible heat storage body and can be used to convert the thermal energy to electrical energy using a generator. The heat transfer fluid can comprise any fluid adapted to transfer heat energy by both conduction and convection, including but not limited to, water, steam and supercritical carbon dioxide (sCO₂). In a preferred embodiment, the heat transfer fluid is flowed through a heat exchanger having an inlet and an outlet disposed along a heat exchanger channel of the sensible heat storage body such that the heat transfer fluid is in energy/thermal communication with the sensible heat storage body.

During energy discharge (extraction), the heat transfer fluid flows through the heat exchanger to be heated by the sensible heat storage body having a higher temperature, when disposed along the heat exchanger channels. Heat transfer occurs typically by conduction from the sensible energy storage body to the heat transfer fluid (HTF) via the heat exchanger. The flow of said heat transfer fluid provides extraction of energy in the form of thermal energy (heat) from the sensible heat storage body in a controlled manner. Extraction of energy by the heat transfer fluid can occur by any number of factors, for example, relative temperature difference between the sensible storage energy body and HTF, HTF flow rate and the type of HTF used.

In one embodiment, the heat transfer medium is a supercritical fluid such as air or supercritical carbon dioxide, preferably supercritical carbon dioxide. In preferred embodiments, the heat transfer medium does not change phase when storing or extracting energy. In these embodiments, the heat transfer medium can be used for high temperature applications such as Brayton cycle generators which have operating temperatures ranging from about 400° C. to about 1000° C.

As no phase change of the heat transfer medium occurs when using a supercritical fluid, higher energy transfer efficiencies and use in higher temperature applications are suitable.

In some embodiments, the heat transfer fluid is selected from the group consisting of liquid sodium (Na); liquid potassium (K), liquid NaK, liquid tin (Sn), liquid lead (Pb), liquid lead-bismuth (PbBi) and combinations thereof. In some embodiments, the heat transfer fluid is selected from the group consisting of liquid sodium (Na); liquid potassium (K), liquid NaK (77.8% K), liquid tin (Sn), liquid lead (Pb), liquid lead-bismuth (PbBi) (45%/55%) and combinations thereof.

In certain embodiments, the heat transfer medium is selected from the group consisting of water, supercritical carbon dioxide, compressed air, compressed nitrogen, organic fluids (such as thermal oils including Dowtherm A), salt hydrates, liquid metals (such as mercury and potassium) and combinations thereof.

Additives such as ethylene glycol, diethylene glycol, propylene glycol, betaine, hexamine, phenylenediamene, dimethylethanolamine, sulphur hexafluoride, benzotriazole, zinc dithiophosphates, nanoparticles, polyalkylene glycols and combinations thereof can be added or mixed with the heat transfer medium to inhibit corrosion, alter the viscosity and enhance thermal capacity.

In certain embodiments, the flow rate of the heat transfer medium per sensible heat storage body (for example, graphite panel) is between about 2.5 to about 250 kg/min, between about 2.5 to about 150 kg/min, between about 2.5 to about 100 kg/min, between about 15 to about 120 kg/min, between about 100 to about 150 kg/min, between about 50 to about 250 kg/min, between about 100 to about 250 kg/min, between about 150 to about 250 kg/min, 2.5 to about 50 kg/min, between about 2.5 to about 40 kg/min, between about 5 to about 40 kg/min, between about 10 to about 30 kg/min, between about 10 to about 20 kg/min, between about 25 to about 35 kg/min and between about 15 to about 30 kg/min. In preferred embodiments, the flow rate of the heat transfer medium is between about between about 15 to about 120 kg/min

The flow rate of the heat transfer medium per sensible heat storage body (for example, graphite panel) can be at any suitable rate which is sufficient to transfer energy between the heat exchanger and sensible heat storage body. In certain embodiments, the flow rate of the heat transfer medium is between about 2.5 to about 250 L/min, between about 2.5 to about 150 L/min, between about 2.5 to about 100 L/min, between about 50 to about 250 L/min, between about 100 to about 250 L/min, between about 150 to about 250 L/min, 2.5 to about 50 L/min, between about 2.5 to about 40 L/min, between about 5 to about 40 L/min, between about 10 to about 30 L/min and between about 10 to about 25 L/min. In preferred embodiments, the flow rate of the heat transfer medium is between about 10 to about 30 L/min.

Depending on the flow rate and heat transfer medium used, the rate of temperature change for storing or extracting energy (for example, energy transfer to the sensible heat storage body or to the heat transfer medium) can be adjusted as required. In some embodiments, the average temperature change during energy storage and/or discharge of the energy storage apparatus is between about 5 to about 100° C./min, between about 5 to about 80° C./min, between about 5 to about 60° C./min, between about 5 to about 50° C./min and more preferably between about 5 to about 30° C./min.

In some embodiments, the heat transfer fluid is a working fluid. In preferred embodiments, the working fluid is supercritical CO 2 . As would be understood by a skilled addressee, a heat transfer fluid is a medium (such as a gas or liquid and the like) which allows passive transfer of energy, typically, thermal energy. As would be understood by a skilled addressee, a working fluid is a medium (such as a gas or liquid and the like) that primarily transfers force, motion, or mechanical energy. Typically, the working fluid converts thermal energy to mechanical energy such as supercritical CO₂ to power a Brayton cycle generator or turbine to generate electricity.

In certain embodiments, the working fluid has an operating temperature ranging between about 400° C. to about 1000° C., between about 400° C. to about 850° C., between about 500° C. to about 800° C., between about 400° C. to about 775° C. and between about 400° C. to about 675° C.

In certain embodiments, the working fluid has an operating pressure ranging between about 20 bar to about 350 bar (about 2 MPa to about 35 MPa), between about 20 bar to about 300 bar (about 2 MPa to about 30 MPa), between about 20 bar to about 250 bar (about 2 MPa to about 25 MPa), between about 50 bar to about 350 bar (about 5 MPa to about 35 MPa), between about 50 bar to about 300 bar (about 5 MPa to about 30 MPa), between about 50 bar to about 250 bar (about 5 MPa to about 25 MPa), between about 70 bar to about 250 bar (about 7 MPa to about 25 MPa), between about 80 bar to about 250 bar (about 8 MPa to about 25 MPa), more preferably between about 100 bar to about 250 bar (about 10 MPa to about 25 MPa). In certain embodiments, the working fluid has an operating temperature ranging between about 400° C. to about 775° C. at 250 bar (about 25 MPa) and more preferably between about 400° C. to about 675° C. at 250 bar (about 25 MPa).

### Energy Storage Apparatus

According to another aspect, the present invention provides an energy storage apparatus comprising: a sensible heat storage body having a heat exchanger channel and a heating element channel adapted to receive a removable heating element; and a heat exchanger having an inlet and an outlet, wherein at least a portion of the heat exchanger is disposed along the channel.

In preferred embodiments, the energy storage apparatus is a thermal energy storage apparatus.

The energy storage apparatus of the present invention provides at least one of the following advantages over the prior art provides for easier maintenance allowing the removable heating elements to be replaced and/or repaired as required, improves energy storage efficiency as the removable heating element is located internally of the energy storage apparatus and can reduce operational costs by requiring fewer heating elements.

The person skilled in the art would appreciate that the sensible heat storage body can be, but is not necessarily required to be, constructed from a single piece of material (a unit body). While in some embodiments, the sensible heat storage body is a unit body, in others it is assembled by component parts.

Constructing the sensible heat storage body from component parts can provide ease of fabrication and assembly. Each component part of the sensible heat storage body can be fabricated to comprise the requisite heating element channel and/or heat exchanger channel to accommodate the heating element and/or heat exchanger. Advantageously, when the sensible heat storage body is assembled from component parts, costs can be reduced from not having to fabricate the channels from a unit body which adds complexity and can provide increased flexibility and repairability when replacing damaged or components of the energy storage apparatus.

### Heating Element

In certain embodiments, the heating element comprises an elongated heating portion at one end, a thermally insulated portion at an opposite end, and wherein the thermally insulated portion further comprises an electrical conductor adapted to be in electrical communication with an electrical terminal. In preferred embodiments, the electrical terminal is located at a thermally insulated portion of the heating element. In this embodiment, the thermally insulated portion does not have a resistance portion (such as a resistance wire) for heating but rather only a conducting portion (such as a conducting wire or pin). Advantageously, the thermally insulated portion (‘cold leg’) can provide a temperature barrier to prevent or reduce the amount of thermal energy from the heating portion (‘hot leg’) reaching the electrical terminals to improve the operating life of the heating element by reducing the amount of hot gas reaching the electrical terminals. An issue with disclosed heating elements is that the electrical terminals of the heating elements can over-heat and fail prematurely as a result.

In some embodiments, the thermally insulated portion of the heating element is tapered. In some embodiments, the thermally insulated portion of the heating element is stepped. In certain embodiments, the thermally insulated portion comprises a plurality of steps. In certain embodiments, the thermally insulated portion of the heating element comprises at least one, at least two, at least three, at least four, at least five, at least six, at least seven, at least eight, at least nine or at least ten steps. In certain embodiments, the thermally insulated portion of the heating element comprises one, two, three, four, five, six, seven, eight, nine or ten steps. In preferred embodiments, each step of the thermally insulated portion of the heating element is independent.

As would be appreciated by a skilled addressee, any suitable thermally insulating material can be used for the thermally insulated portion of the heating element. In one embodiment, the thermally insulated portion of the heating element is a ceramic insulator. Examples of suitable ceramic insulator materials include metal oxides such as beryllium oxide, magnesium oxide, calcium oxide, strontium oxide, osmium oxide, lanthanum trioxide, yttrium trioxide, scandium trioxide, titanium dioxide, zirconium dioxide, hafnium dioxide, tantalum pentoxide, niobium pentoxide, alumina, silica, nickel oxide, and other inorganic materials such as silicon nitride, silicon carbide, boron carbide, tantalum carbide, titanium carbide, tungsten carbide, zirconium carbide, aluminium nitride, zirconium boride, spinel, mullite, forsterite, fireclay, dolomite, magnesite, high alumina porcelains, high-magnesia porcelains, sillimanite, kyanite, zirconium silicate and combinations thereof. In some embodiments, the thermally insulated portion is a material selected from the group consisting of aluminium oxide, magnesium oxide, beryllium oxide, chromium oxide, silicon carbide, zircon, mica, fiberglass, mullite, porcelain, vitreous china, steatite, cordierite, sillimanite and combinations thereof. In preferred embodiments, the thermally insulated portion is a material selected from the group consisting of silica, calcium oxide, magnesium oxide, alumina and combinations thereof.

In certain embodiments, the heating portion of the heating element comprises a resistance wire selected from a material including but not limited to metallic alloys with high electrical resistivity and temperature resistance, surrounded by an electrical insulator and enclosed by a metal or alloy casing. By encasing the heating element, when the sensible heat storage body is graphite, ingress of graphite powder when in contact with the heating element is prevented or minimised. The resistance wire can be selected from a material selected from alloys comprising any one of nickel, chromium, copper and manganese. In preferred embodiments, the resistance wire is a material selected from the group consisting of NiChrome (80% nickel, 20% chromium), Kanthal (FeCrAl), Cupronickel (CuNi) alloys and etched foil (typically made from the same materials as the resistance wire). In some embodiments, the electrical insulator is a material selected from the group consisting of aluminium oxide, magnesium oxide, beryllium oxide, chromium oxide, silicon carbide, zircon, mica, fiberglass, mullite, porcelain, vitreous china, steatite, cordierite, sillimanite.

The metal or alloy casing can be made of robust material such as alloys of nickel, chromium, iron and cobalt which are high temperature, corrosion and pressure resistant. In a preferred embodiment, the metal or alloy casing is an selected from the group consisting of alloy 600, alloy 601, alloy 625, alloy 602CA, alloy 617, alloy 718, alloy 740H, alloy 230, alloy X, HR214, HR224, IN600, IN740, Haynes 282, Haynes 230, 347SS, 316L, AFA-OC6, C-276, P91/T122, 316SS, IN601, IN800H/H, Hastelloy X, CF8C+, HR230, IN61, IN62, 253MA, 800H, 800HT, RA330, 353MA, HR120, RA333 and combinations thereof. In a more preferred embodiment, the metal or alloy casing is an Inconel or Incoloy (nickel-chromium based alloy).

In further embodiments, the heating element can be an electrical resistor. This is used to convert electrical energy to thermal energy to directly heat the sensible heat storage body, representing a direct conversion to and delivery of useful heat energy to the sensible heat storage body. The heating element can comprise at least one tubular loop of electrically resistive material to heat the inner region of the sensible heat storage body. The tubular loop can be U-shaped or trombone shaped.

In an embodiment, the at least one tubular loop provides heat when it is in electrical communication with an electrical terminal. Effectively, the electricity supplied from the electrical terminal is electrically conducted through the at least one tubular loop.

In certain embodiments, each heating element comprises between about one to twelve tubular loops, between about one to ten tubular loops, between about one to eight tubular loops, between about two to six tubular loops, preferably between about three to six tubular loops. In certain embodiments, each heating element comprises at least one, at least two, at least three, at least four or at least five tubular loops. In some embodiments, each heating element comprises one, two, three, four, five, six, seven, eight, nine, ten, eleven or twelve tubular loops. In some embodiments, the heating element comprises three trombone tubular loops. In some embodiments, the heating element comprises six U-shaped tubular loops.

In preferred embodiments, the heating element is sealingly engaged with the energy storage apparatus. In certain embodiments, the heating element is sealingly engaged with the sensible heat storage body. In preferred embodiments, the heating element is sealingly engaged with an enclosure enclosing the sensible heat storage body. The enclosure can provide a barrier between the surrounding atmosphere and the sensible heat storage body, which can be used to substantially prevent the loss of heat from the body, as well as ingress of air which can oxidise the body subject to the material used and its operating temperature. In this preferred embodiment, the enclosure has at least one aperture to receive a heating element. The at least one aperture for receiving a heating element can comprise a sealing flange. The heating element can then be fastened to the sealing flange to provide a seal. The heating element can be fastened to the sealing flange of the enclosure using any suitable manner, for example, using nut and bolt, screw, clamp, tapered screw coupling or latch. In some embodiments, the heating element can be sealingly engaged to the enclosure by a tapered screw coupling or bolted flange to provide a seal. In further embodiments, the sealing flange further comprises a sealing gasket to provide a gas tight seal.

In more preferred embodiments, the energy storage apparatus comprises insulation. The insulation is typically disposed between the sensible heat storage body and the enclosure. In this embodiment, the thermally insulated portion of the heating element abuts and compresses the insulation providing a hot gas seal, blocking or reducing the egress of hot gas to the electrical terminals. Advantageously, the sealing engagement between the heating element and the energy storage apparatus as discussed above provides adequate cooling to the electrical terminals of the heating element to minimise overheating and premature failure. In preferred embodiments, the heating element has an air-cooled portion disposed between the thermally insulated portion and electrical terminal which is located externally of the enclosure of the energy storage apparatus.

In certain embodiments, one end of the heating element channel which is adapted to receive the thermally insulated portion is tapered. In this embodiment, the tapered heating element channel can provide an improved sealing engagement between the heating element and optionally insulation.

The insulation can suitably be located on a surface of the sensible heat storage body to minimise the amount of thermal energy lost to the external environment. The insulation can reduce the risk of an operator burning themselves during operation of the energy storage apparatus. In some embodiments, the insulation can comprise a plurality of insulation layers using different materials.

Suitable materials for the insulation can be selected from the group consisting of thermal insulation boards, alkaline earth silicate wool, thermal insulation blanks, fiberglass, inorganic oxide, silica-based wool, mineral wool, polymers, and foams. For example, multiple layers of insulation materials of different specifications, can be used to prevent energy loss. It should also be appreciated that any insulation that is able to accommodate the high temperatures can be used in the energy storage apparatus.

As would be appreciated by a skilled addressee, the energy storage can comprise any suitable number of heating elements depending on a number of factors such as desired operating temperature, thermal energy storage heat up rate, size of heating element and power efficiency of the heating element. In some embodiments, the energy storage apparatus comprises at least one, at least two, at least three, at least four, at least five, at least six, at least seven, at least eight, at least nine, at least ten, at least twenty or at least thirty heating elements. In certain embodiments, the energy storage apparatus comprises one, two, three, four, five, six, seven, eight, nine, ten, eleven, twelve, thirteen, fourteen, fifteen, sixteen, seventeen, eighteen, nineteen, twenty, twenty one, twenty two, twenty three, twenty four, twenty five, twenty six, twenty seven, twenty eight, twenty nine, thirty, thirty one, thirty two, thirty three, thirty four or thirty five heating elements. In preferred embodiments, the energy storage apparatus comprises thirty two heating elements. A plurality of heating elements can provide more uniform and rapid heat transfer to the sensible heat storage body, such that it can be heated to operational temperatures more efficiently.

The removable heating element used in the present invention can be any suitable power density. In certain embodiments, the power density per heating element is between about 5 W/in² to about 50 W/in², between about 5 W/in² to about 40 W/in², between about 5 W/in² to about 30 W/², between about 5 W/in² to about 30 W/in², between about 10 W/in² to about 30 W/in², between about 15 W/in² to about 30 W/in². In preferred embodiments, the power density per heating element is between about 5 W/in² to about 15 W/in².

The removable heating element used in the present invention can be any suitable power. In certain embodiments, the power per heating element is between about 1 to 50 kW, between about 5 to 50 kW, between about 5 to 40 kW, between about 5 to 30 kW, between about 5 to 20 kW, between about 10 to 20 kW, more preferably about 15.4 kW.

In certain embodiments, the heating element channel of the sensible heat storage body further comprises a bore. The bore is typically disposed at a distal end in proximity to the heating portion of the heating element in use (i.e., the bore is typically located opposite the opening of the heating element channel which receives the removable heating element). In these embodiments, the bore allows gas present in the heating element channel to egress when heating the inner region of the sensible heat storage body during use by avoiding gas pressure build-up. This can avoid compromise of the gas tight seal when the heating element is sealingly engaged to the energy storage apparatus due to overpressure. The bore can also allow the heating element channel to breathe out expanded gas (such as inert gas) when hot and breathe in gas when cooled. The heating element channel also allows the longitudinal expansion of the heating element when heated.

The energy storage apparatus can comprise a plurality of bores. In preferred embodiments, the energy storage apparatus comprises a bore per heating element channel.

In use, a portion of the heating element is in contact with the inner region of the sensible heat storage body. In preferred embodiments, the heating portion of the heating element is in contact with the inner region of the sensible heat storage body. In preferred embodiments, the at least one tubular loop of the heating element contacts the sensible heat storage body when the heating element is inserted into the heating element channel. This provides for efficient conduction of the heat from the heating elements to the sensible heat storage body. Advantageously, improved contact between the heating portion of the heating element and the surface of the inner region of the sensible heat storage body can occur in use because during heating, the heating portion of the heating element can expand.

When the sensible heat storage body is graphite, the heating element of the present invention can be of high watt density (such as between about 5 W/in² to about 50 W/in²), thereby reducing the heating element surface area and number of heating elements required and therefore subsequent cost. This is because graphite has low emissivity, high thermal conductivity and high specific heat.

### Heat Exchanger

In some embodiments of the present invention, the sensible heat storage body comprises one or more heat exchanger channels along an outer surface of the sensible heat storage body, wherein a portion of the heat exchanger is disposed along at least one of the one or more heat exchanger channels. In some embodiments, the sensible heat storage body is comprised of component parts (such as panels), wherein at least one component comprises one or more heat exchanger channels along an outer surface of the component part and a portion of the heat exchanger is disposed along at least one of the one or more heat exchanger channels. In this regard, heat exchanger channels can provide direct contact of the heat exchanger with the sensible heat storage body. When the heat exchanger is in direct contact with the sensible heat storage body, heat or thermal energy can be transferred between the heat exchanger and the storage body by conduction, which is inherently more efficient than convection or circulation of heated gases between two materials. During energy discharge, the direct contact allows heat to be transferred from the sensible heat storage body to the heat transfer medium.

Preferably, the sensible heat storage body comprises a heat exchanger channel having at least two open ends within the sensible heat storage body. In this embodiment, the two open ends are orifices of the heat exchanger channel disposed internally in the sensible heat storage body. In this embodiment, at least a portion of the heat exchanger when disposed along said channel, is embedded within or internal of the sensible heat storage body. Advantageously, this can increase the surface area of the heat exchanger which is in contact with the sensible heat storage body. Increasing the contact surface area between the heat exchanger and the sensible heat storage body can increase the efficiency of energy transfer between the heat transfer medium and sensible heat storage body during discharge.

Heat exchangers of the present invention can take many shapes and sizes depending on the requirements for flow rate of the heat transfer fluid, the size, material and conductivity of the sensible heat storage body and the operational requirements at operating pressures and temperatures.

In one embodiment, the heat exchanger is in the shape of a serpentine coil or a helical coil. Coiling structures of enclosed conduits comprise the heat exchanger in order to maximise the number of passes the heat exchanger makes while disposed along the heat exchanger channels. In preferred embodiments, the heat exchanger is in the shape of a serpentine coil. Advantageously, a serpentine coil heat exchanger provides a more uniform temperature profile across the sensible heat storage body during energy/heat extraction because when the heat transfer fluid flows through the heat exchanger, the heat in the sensible heat storage body transfers throughout the body. Each pass of the heat exchanger is typically adequately offset in order to maximise the bulk volume of the storage body material that the heat exchanger is in thermal communication with, in order to make the heat transfer as uniform as possible. In some embodiments, multiple parallel passes of the enclosed conduit disposed in a perpendicular direction relative to the overall direction of flow for the heat transfer medium. For example, the parallel passes are in fluid communication with each other by about 180 degree turns which over their length rise by a set distance to offset the otherwise overlapping passes. This rise of the serpentine coil allows the passes to be offset from each other and brings the heat exchanger into thermal communication with a larger bulk volume of the sensible heat storage body.

In certain embodiments, each turn of the serpentine coil can be either in the same plane or in alternating planes. The former would result in the parallel passes of embedded heat exchanger to be arranged in along a single plane, while the latter can result in the parallel passes arranged in at least two planes, preferably at least two parallel planes, between which the embedded heat exchanger rises in alternating fashion similar to a stairwell. As a result of the rises, each sequential alternating parallel pass of the latter design are offset along two axes.

Surprisingly, the present inventors found that a rising serpentine coil heat exchanger provides more flexibility in adjusting the contact area of heat exchanger with the sensible heat storage body. For example, if each rise of the heat exchanger is 50 mm and corresponding to 50 mm thick sensible heat storage body component, a 160 mm bend radius can be achieved with the heat exchanger having about 40 horizontal passes of heat exchanger embedded and in contact with the sensible heat storage body for a 2 m high body. This can be significant as the extraction rate of thermal energy by the rising serpentine coil is 3 times greater compared to a heat exchanger coil having a vertical coil design (alternating passes in the same plane) as more passes can be provided.

Another advantage of a serpentine coil heat exchanger is that the parallel passes of the enclosed conduit can be offset by set distances to accommodate certain design requirements including turn diameters and the overall heat transfer capacity specified by the desired maximum and minimum energy discharge rates from the sensible heat storage body. In an embodiment, each turn of the serpentine coil has a rise of between about 20 mm to about 150 mm, between about 20 mm to about 140 mm, between about 20 mm to about 120 mm, between about 20 mm to about 110 mm, between about 20 mm to about 100 mm, between about 20 mm to about 80 mm, between about 50 mm to about 100 mm, between about 50 mm to about 80 mm, between about 60 mm to about 80 mm, between about 70 mm to about 80 mm, between about 20 mm to about 70 mm, between about 20 mm to about 60 mm, between about 30 mm to about 60 mm, preferably about 75 mm. In preferred embodiments, each turn of the serpentine coil has a rise of substantially the same thickness as a component of the sensible heat storage apparatus.

As disclosed above, the sensible heat storage body can be constructed from multiple component parts, which preferably slot together while accommodating the heat exchanger. The component construction is further enabled in embodiments where each turn of the serpentine coil has a rise of substantially the same thickness as a component of the sensible heat storage body. Effectively, each component part is slotted in between the offset passes of the enclosed conduit for its respective heat exchanger channel to make direct contact with both the pass above and below. This design is both efficient and effective, as construction complexity is minimised by the unit block construction, while maximising contact surface area for heat conduction.

In some embodiments, the heat exchanger comprises between about 10 to about 80 passes, between about 20 to about 60 passes, between about 30 to about 50 passes, between about 20 to about 40 passes, between about 20 to about 30 passes, between about 20 to about passes, about 40 passes, or preferably about 23 passes per heat exchanger in the sensible heat storage body.

As would be appreciated, the heat exchanger can have any suitable bend radius which can depend on the material of the heat exchanger used and the operating conditions. In some embodiments, each turn of the heat exchanger has a bend radius of between about 1D to about 5D, between about 2D to about 4D, preferably 3D; where D is the outside diameter of the pipe. The preferred embodiment wherein the bend radius of each heat exchanger is about 3D is based on the American Society of Mechanical Engineers standard ASME B31.3, which recommends a bend radius of 3D when operating at high pressures and temperatures.

In preferred embodiments, the heat exchanger is sealingly engaged with the energy storage apparatus. In certain embodiments, the heat exchanger is sealingly engaged with the sensible heat storage body. In preferred embodiments, the heat exchanger is sealingly engaged with an enclosure enclosing the sensible heat storage body. In this preferred embodiment, the enclosure has at least one aperture to receive a heat exchanger. The at least one aperture for receiving a heat exchanger can comprise a sealing flange such as an insulating bush, sealing gasket and the like. In some embodiments, the heating element can be sealingly engaged to the enclosure by an insulating bush in contact with the heat exchanger and insulation providing a gas tight seal as well as insulating the hot heat exchanger to the cooler enclosure (relative to the sensible heat storage body in use). In further embodiments, the sealing flange further comprises a sealing gasket to provide a gas tight seal.

Advantageously, when the heat exchanger is sealingly engaged to the energy storage apparatus, preferably sealingly engaged with the enclosure, heat can be retained within the sensible heat storage body and not “leak” via the hot heat exchanger contacting the enclosure in use. This can be provided by a gas tight seal and also when the energy storage further comprises insulation.

It should be appreciated by a skilled addressee that the heat exchanger channel can take any geometry or size depending on the flow rate required through the heat exchanger. In one embodiment, the heat exchanger channel is a recess. In other embodiments, the channel is tubular. In certain embodiments, the tubular channel has a cross-sectional shape selected from the group consisting of a circle, square, rectangular, ellipse, triangular, quadrilateral, pentagon, hexagon, nonagon, hexagon, heptagon, octagon or irregular shape. In preferred embodiments, the tubular channel is a circular or semi-circular channel. In some embodiments, the energy storage apparatus comprises a plurality of channels. In some embodiments, the energy storage apparatus comprises two, three, four, five, six, seven, eight, nine or more channels. In some embodiments, the plurality of channels are configured as independent circuits.

As would be appreciated by a person skilled in the art, the heat exchanger can be of any geometry or material depending on the application and temperature required. In preferred embodiments, the shape of the heat exchanger will be complementary to the channel of the sensible heat storage body such that the heat exchanger can fit in the heat exchanger channel and transfer energy to and/or from the sensible heat storage body.

It should be appreciated that the energy storage apparatus can comprise a plurality of heat exchangers. In certain embodiments, the energy storage apparatus comprises two, three, four, five, six, seven, eight, nine, ten or more heat exchangers. In some embodiments, each heat exchanger is a separate independent circuit such that each heat exchanger can either be used to input energy or to extract energy as required. In certain embodiments where the heat exchanger can be used to input energy, this can be in addition to the heating providing during storage by the removable heating elements.

In some embodiments, the heat exchanger is tubular. In certain embodiments, the tubular heat exchanger has a cross-sectional shape selected from the group consisting of a circle, square, rectangular, ellipse, triangular, quadrilateral, pentagon, hexagon, nonagon, hexagon, heptagon, octagon or irregular shape. In preferred embodiments, the tubular heat exchanger is a circular heat exchanger. In some embodiments, the heat exchanger comprises a fin (such as a wavy fin, a pin fin, a straight fin, a cross-cut fin, an elliptical fin or a honeycomb fin), a wire-mesh, or a combination thereof disposed on the surface of the heat exchanger. In some embodiments, the fin is a pin fin. In certain embodiments, the fins can be inline, staggered or a combination thereof.

In one embodiment, the material of the heat exchanger is an alloy, titanium or a ceramic. In some embodiments, the material of the heat exchanger is a superalloy or high temperature ceramic such as a refractory ceramic. Preferably, the material of the heat exchanger is resistant to oxidation or degradation at operating temperatures. In one embodiment, the material of the heat exchanger is selected from the group consisting of borides, carbides, nitrides, oxides of transition metals and combinations thereof. In one embodiment, the oxides of transition metals are selected from the group consisting of hafnium diboride, zirconium diboride, hafnium nitride, zirconium nitride, titanium carbide, titanium nitride, thorium dioxide, tantalum carbide and combinations thereof.

In certain embodiments, the material of the heat exchanger is a superalloy selected from the group consisting of a nickel-based superalloy, cobalt-based superalloy, iron-based superalloy, chromium-based superalloy and combinations thereof.

In certain embodiments, the superalloy is selected from the group consisting of titanium grade 2 alloy, TP439, A129-4C, A12003, A12205, A12507, TP304, TP316, TP317, 254SMO, AL6XN, alloy, 309S, alloy 310H, alloy 321H, alloy 600, alloy 601, alloy 625, alloy 602CA, alloy 617, alloy 718, alloy 740H, alloy 230, alloy X, HR214, HR224, IN600, IN740, Haynes 282, Haynes 230, 347SS, 316L, AFA-OC6, C-276, P91/T122, 316SS, IN601, IN800H/H, Hastelloy X, CF8C+, HR230, IN61, IN62, 253MA, 800H, 800HT, RA330, 353MA, HR120, RA333, and combinations thereof. In preferred embodiments, the material of the heat exchanger is alloy 625, alloy 740H, alloy 230, alloy 617, 800HT and combinations thereof. Non-limiting suitable alloy materials for heat exchangers and heating element casing are shown in Table 1.

TABLE 1
Potential heat exchanger materials and heating element casing materials

| | | UNS | EN |
|---|---|---|---|
| Material | Composition (wt %)* | No. | No. |
| Alloy 321H | 17-19 Cr, 9-12 Ni, 0.04-0.10 C, 2 Mn, 0.045 P, 0.03 S, | S32109 | 1.4878 |
| | 0.75 Si, 4 × (C + N) − 0.7 Ti, 0.10 N, Fe (balance) | | |
| Alloy 309S | 22-24 Cr, 12-15 Ni, 0.08 C, 2 Mn, 0.045 P, 0.03 S, 0.75 | S30908 | 1.4833 |
| | Si, 4 × (C + N) − 0.7 Ti, 0.10 N, Fe (balance) | | |
| Alloy 800H | 30-35 Ni, 19-23 Cr, 39.5 Fe, 0.05-0.10 C, 1.50 Mn, | N08810 | 1.4958 |
| | 0.045 P, 0.015 S, 1.0 Si, 0.15-0.60 Al, 0.15-0.60 Ti, | | |
| | 0.3-1.2 Al + Ti | | |
| Alloy 800HT | 30-35 Ni, 19-23 Cr, 39.5 Fe, 0.06-0.10 C, 1.50 Mn, | N08811 | 1.4959 |
| | 0.045 P, 0.015 S, 1.0 Si, 0.25-0.60 Al, 0.25-0.60 Ti, | | |
| | 0.85-1.2 Al + Ti | | |
| Alloy 253MA | 0.05-012 C, 1.40-2.50 Si, 1.00 Mn, 0.045 P, 0.015 S, | S30815 | 1.4835 |
| | 20-22 Cr, 10-12 Ni, 0.12-0.20 N, 0.03-0.08 Ce, Fe | | |
| | (balance) | | |
| Alloy 310H | 24-26 Cr, 19-22 Ni, 0.04-0.10 C, 2 Mn, 0.045 P, 0.03 | S31009 | — |
| | S, 0.75 Si, Fe (balance) | | |
| Alloy RA330 | 17-20 Cr, 34-37 Ni, 0-2 Mn, 0.75-1.5 Si, 0-1 Cu, 0-0.03 | N08330 | 1.4886 |
| | P, 0-0.03 S, 0.04-0.08 C, Fe (balance) | | |
| Alloy 353MA | 37.18 Fe, 35 Ni, 25 Cr, 1.3 Ce, 1.3 Si, 0.17 N, 0.05 C | S35315 | 1.4854 |
| Alloy HR120 | 30-45 Ni, 12-32 Cr, 5 Co, 5 Mo, 4 Cb + Ta, 3 Si, 2 Mn, | N08120 | 2.4854 |
| | 0.2 C | | |
| Alloy RA333 | 44-47 Ni, 24-27 Cr, 2.5-4 Mo, 2.5-4 Co, 2.5-4 W, 0-0.08 | N06333 | 2.4608 |
| | C, 0.75-1.5 Si, 0-2 Mn, 0-0.03 P, 0-0.03 S, Fe (balance) | | |
| Alloy 625 | 58 min Ni, 20-23 Cr, 5 max Fe, 8-10 Mo, 3.15-4.15 | N06625 | 2.4856 |
| | Nb + Ta, 0.1 max C, 0.5 max Mn, 0.5 max Si, 0.015 max | | |
| | P, 0.015 S, 0.4 max Al, 0.4 max Ti, 1 Co | | |
| Alloy 600 | 72 min Ni + Co, 14-17 Cr, 6-10 Fe, 0.15 max C, 1 max | N06600 | 2.4816 |
| | Mn, 0.015 S, 0.5 Si, 0.5 Cu | | |
| Alloy 601 | 58-63 Ni, 21-25 Cr, 16 Fe, 1-1.7 Al, 0.1 max C, 1.5 max | N06601 | 2.4851 |
| | Mn, 0.5 Si, 0.015 max S, 1 Cu | | |
| Alloy 602 CA | 24-26 Cr, 8-11 Fe, 0.15-0.25 C, 0-0.5 Mn, 0-0.5 Si, | N06025 | 2.4633 |
| | 0-0.1 Cu, 1.8-2.4 Al, 0.1-0.2 Ti, 0.05-0.12 Y, 0.01-0.1 Zr, | | |
| | 0-0.02 P, 0-0.01 S, Ni (balance) | | |
| Alloy X | 0.05-0.15 C, 0-1 Mn, 0-0.04 P, 0-0.03 S, 0-1 Si, 20.5- | N06002 | 2.4665 |
| | 23 Cr, 8-10 Mo, 0-0.15 Ti, 0-0.5 Al, 17-20 Fe, 0-0.01 B, | | |
| | 0.5-2.5 Co, 0.2-1 W, 0-0.05 Cu, Ni (balance) | | |
| Alloy 617 | 44.5 min Ni, 20-24 Cr, 10-15 Co, 8-10 Mo, 0.8-1.5 Al, | N06617 | 2.4663a |
| | 0.05-0.15 C, 3 max Fe, 1 max Mn, 1 max Si, 0.015 max | | |
| | S, 0.6 max Ti, 0.5 max Cu, 0.006 max B | | |
| Alloy 230 | 57 (balance) Ni, 22 Cr, 14 W, 2 Mo, 3 max Fe, 5 max | N06230 | 2.4733 |
| | Co, 0.5 Mn, 0.4 Si, 0.5 max Nb, 0.3 Al, 0.1 max Ti, 0.1 | | |
| | C, 0.02 La, 0.015 max B | | |
| Alloy 740H | 23.5-25.5 Cr, 15-22 Co, 0.2-2 Al, 0.5-2.5 Ti, 0.5-2.5 Nb, | N07740 | — |
| | 0-3 Fe, 0.005-0.08 C, 0-1 Mn, 0-2 Mo, 0-1 Si, 0-0.5 Cu, | | |
| | 0-0.03 P, 0-0.03 S, 0.0006-0.006 B, Ni (balance) | | |
| Alloy C-276 | 57 (balance) Ni, 2.5 max Co, 16 Cr, 16 Mo, 5 Fe, 4 W, | N10276 | 2.4819 |
| | 1 max Mn, 0.35 max V, 0.08 max Si, 0.01 max C, 0.5 | | |
| | max Cu | | |
| Alloy 282 | 57 (balance) Ni, 20 Cr, 10 Co, 8.5 Mo, 2.1 Ti, 1.5 Al, | N07208 | — |
| | 1.5 max Fe, 0.3 max Mn, 0.15 max Si, 0.06 C, 0.005 B | | |

*slight composition variations may occur.

In some embodiments, the material of the heat exchanger is selected from the group consisting of silicon carbide, graphite, reinforced polymer, clay, porcelain, carbon nanotubes, aluminium nitride, aluminium oxide, boron nitride, silicon nitride, steel, mullite, zirconium oxide, ductile iron, cast iron, stainless steel, alloys of columbian, tantalum, molybdenum, tungsten and combinations thereof.

### Attemperation

Attemperation is a process by which two or more flows of similar or the same fluid are mixed in order to adjust fluid properties including, but not limited to, moisture content, temperature and phase. For example, a heat transfer fluid having a lower temperature can be mixed with a heat transfer fluid having a higher temperature to prolong the energy discharge of the energy storage apparatus at a lower operating temperature than the maximum operating temperature. In this embodiment, with sensible heat storage extraction, the discharge heat transfer fluid temperature starts at the maximum storage temperature and reduces to a lower or minimum temperature as heat is extracted from the sensible heat storage body.

In the present invention, attemperation is performed in one embodiment where heat transfer fluid is mixed with an additional heat transfer fluid having different temperatures. In one embodiment, the additional heat transfer fluid has a temperature greater than the heat transfer fluid. In other embodiments, the additional heat transfer fluid has a temperature lower than the heat transfer fluid.

In certain embodiments, a portion of an inlet heat transfer fluid (lower temperature) of the heat exchanger is mixed with an outlet heat transfer fluid (higher temperature) maintaining a set operational temperature for a longer duration during discharge.

Preferably, the heat transfer fluid is mixed with an additional heat transfer fluid having a temperature greater than the temperature of the heat transfer fluid. The additional heat transfer fluid can be a separate stream when mixed with the heat transfer fluid of the energy storage apparatus. In preferred embodiments, the additional heat transfer fluid and heat transfer fluid of the energy storage apparatus is the same stream. The additional heat transfer fluid and heat transfer fluid can be the same stream by recirculation or when two or more energy storage apparatus are connected in series. For example, when two or more energy storage apparatus are connected in series, the additional heat transfer fluid and heat transfer fluid can be the same stream. In this embodiment, the additional heat transfer fluid can be the discharge fluid from the outlet of the heat exchanger having a higher temperature of one energy storage apparatus which is in fluid communication and mixed with a heat transfer fluid of the inlet of a heat exchanger of another energy storage apparatus having a lower temperature.

In one embodiment, the heat exchanger is further connected to a conduit for fluid communication. In one embodiment, the conduit is connected to the inlet and/or outlet of the heat exchanger. In one embodiment, the conduit is connected to a manifold. In preferred embodiments, the manifold comprises a valve. In some embodiments, the heat transfer fluid and additional heat transfer fluid can be mixed using a valve. In preferred embodiments, the valve is disposed between an inlet manifold and an outlet manifold of a heat exchanger when two or more energy storage apparatus are connected in series. When the valve is open while extracting heat from the sensible heat storage body, the heat transfer fluid in the inlet manifold of a heat exchanger will mix with the comparatively higher temperature additional heat transfer fluid of the outlet manifold of a heat exchanger. This can prolong the extraction or discharge of thermal energy from the energy storage apparatus.

In certain embodiments, the valve is controlled by a control system. A control system can directly or remotely open, shut or partially open or shut the valve in response to operational or fluid parameters obtained data inputs. The control system can include, but is not limited to, computer implemented systems using data obtained from sensors and/or manual inputs, such as feedback and feedforward loops which react to or pre-empt data from sensors and/or thermocouples located for example in the manifold or energy storage apparatus and the like. Preferably, the control system is implemented using a proportional integral derivative (PID) controller in communication with and/or in response to temperature derived from at least one of temperature sensor disposed in the sensible heat storage body, inlet and outlet of the heat exchanger and/or manifold. By using a PID controller to monitor and react to temperature values from the sensors, both automated and more precise control of the heat transfer fluid attemperation as well as heat extraction from the sensible heat storage body can be provided. Better control can result in more efficient heating of and heat extraction from the sensible heat storage body, as well the prolonging of the stored thermal energy extraction to maximise extraction time.

In certain embodiments, the energy storage apparatus discharge is prolonged by at least about 20 minutes, at least 30 minutes, at least 60 minutes, at least 90 minutes, at least 2 hours, at least 3 hours, at least 4 hours compared to without attemperation.

In certain embodiments, the temperature difference between the heat transfer fluid and additional heat transfer fluid between about 50° C. to about 600° C., about 50° C. to about 500° C., about 80° C. to about 600° C., about 100° C. to about 500° C., about 50° C. to about 400° C., about 50° C. to about 300° C., about 50° C. to about 200° C. or about 100° C. to about 600° C. As would be understood by a skilled addressee, the temperature difference is the absolute temperature difference and includes embodiments wherein the heat transfer fluid temperature is greater than the additional heat transfer fluid temperature or vice versa.

### Gas blanketing

In some embodiments, the enclosure surrounding the sensible heat storage body comprises a gas inlet to substantially fill the enclosure with an inert gas and a gas outlet to vent inert gas. By replacing air inside the enclosure with inert gas, an inert gas “blanket” surrounding the energy storage apparatus is provided. Advantageously, the use of inert gas can prevent or ameliorate unwanted reactions such as oxidation due to the high temperature environment of the sensible heat storage body such as oxidation of graphite and can increase operational lifespan. Further, the inert gas “blanket” provides a gas tight enclosure to ‘breathe’ by venting hot inert gas as it expands and ‘breathing’ in cool inert gas as it cools during operation of the energy storage apparatus and can maintain a constant pressure enclosed within the enclosure of the energy storage apparatus of the present invention.

This can prevent potential damage to both the enclosure and the storage body from structural expansion as a result of entrapping high-pressure expanding gases.

As would be appreciated by a skilled addressee, any suitable inert gas can be used in the present invention. In some embodiments, the inert gas is selected from the group consisting of helium, neon, argon, nitrogen, krypton, xenon, radon, carbon dioxide, carbon monoxide and combinations thereof. In preferred embodiments, the inert gas is selected from the group consisting of argon, nitrogen and combinations thereof.

Advantageously, use of an inert gas “blanket” can also prevent or ameliorate a graphite fire when the sensible heat storage body material is graphite.

If a temperature of greater than 1000° C. is used, an inert gas selected from the group consisting of argon, helium and combinations thereof is preferred as nitrogen can potentially form cyanide compounds above these temperatures.

In some embodiments, the fill and vent of inert gas is controlled by a single bidirectional gas valve. In other embodiments, the fill and vent of inert gas is controlled by independent unidirectional gas valves.

In certain embodiments, the fill and vent of inert gas is controlled by an inert gas management system. This inert gas management system can utilise pressure sensors, for example located inside the enclosure or valve, to fill inert gas from a gas reservoir and/or open to vent.

In some embodiments, the pressure of the inert gas within the enclosure of the energy storage apparatus is between about 1 to 100 mbar, between about 1 to 80 mbar, between about 1 to 70 mbar, between about 1 to 600 mbar, between about 1 to 50 mbar, between about 1 to 40 mbar, between about 1 to 30 mbar, between about 1 to 20 mbar and preferably between about 1 to 10 mbar.

In some embodiments, the enclosure comprises structural reinforcement such as ribs to increase the structural integrity of the enclosure to allow for greater internal pressures of the energy storage apparatus of the present invention.

### Phase Change Material

In a further embodiment, the sensible heat storage body further comprises a cavity for receiving a phase change material. Phase change material can be stored inside the cavity to provide multiple operational advantages including latent energy storage and as a thermal barrier when disposed between the heat exchanger and removable heating element. The cavity can take any geometry or size depending on the amount of phase change material to be stored. The cavity may take any suitable shape and may be for example in the shape of a sphere, cube, cylinder, cone, cuboid, prism, tetrahedron or an irregular shape.

In some embodiments, the sensible heat storage body comprises an open cavity. Advantageously, the sensible heat storage body having an open cavity allows for the phase change material to expand in volume when heated and contract in volume when cooled.

In some embodiments, the sensible heat storage body comprises a sealed closed cavity. In this configuration, the phase change material is enclosed and sealed gas-tight within the cavity. In other embodiments, the sensible heat storage body comprises a gas-permeable closed cavity. In this configuration, the cavity is closed but allowing for gas exchange with the external environment. This provides outgassing while allowing inert gas to enter the cavity of the sensible heat storage body storing the phase change material.

In some embodiments, the sensible heat storage body comprises a plurality of cavities. In some embodiments, the sensible heat storage body comprises two, three, four, five, six, seven, eight, nine, ten (or more) cavities. In certain embodiments, the cavity comprises at least one open cavity and at least one closed cavity. In other embodiments, all cavities may be closed, or all cavities may be open.

The phase change material present in the above embodiment can be any suitable material which changes phase (i.e., solid, liquid, gas or plasma) when storing or extracting energy. Phase change materials are latent energy storage materials which can store or extract energy to change the state of a material at almost constant temperature when the material undergoes a phase change. For example, water is a latent energy storage material when undergoing a phase change during freezing and melting.

Preferred phase change materials include any metal, such as aluminium, zinc, lead, tin, magnesium, or an alloy containing any one or more of these metals. Most preferably, the phase change material is aluminium, or an alloy comprising aluminium, or a salt hydrate thereof.

In one embodiment, the phase change material has a phase change temperature up to about 1500° C., up to about 1300° C., up to about 1200° C., or up to about 1000° C. In one embodiment, the phase change material has a phase change temperature between about 80 to about 1500° C., between about 200 to about 1500° C., preferably between about 350 to about 1200° C., preferably between about 500 to about 1500° C., preferably between about 800 to about 1200° C., preferably between about 400 to about 1000° C., more preferably between about 400 to about 850° C., more preferably between about 400 to about 800° C., more preferably between about 550 to about 1000° C. and most preferably between about 600 to about 800° C. The use of a phase change material can increase the cost effectiveness of storing energy.

As discussed above, in certain embodiments, the phase change material advantageously provides a thermal barrier between the removable heating element and the heat exchanger to avoid overheating the heat exchanger and exceeding the heat exchanger materials temperature limit of operation. If a suitable phase change material having a melting temperature close to the maximum operating temperature of the heat exchanger material is chosen, the heat exchanger temperature rise rate can be slowed close to the maximum operating temperature limit making the heat exchanger temperature rise rate easier to control and can ensure that the maximum heat exchanger operating temperature is not exceeded.

### Energy Storage Array

In another aspect, the present invention provides an energy storage array comprising: a plurality of energy storage apparatus as described herein. In preferred embodiments, the energy storage apparatus as described herein are in thermal and/or electrical communication. In certain embodiments, the energy storage array further comprises a conduit disposed between the outlet of the heat exchanger of one energy storage array and an inlet of the heat exchanger of another energy storage array.

In preferred embodiments, the conduit is connected to a manifold having an inlet and an outlet; preferably the manifold comprises a valve between the inlet manifold and the outlet manifold. In certain embodiments, the energy storage array is in the form of a unit, preferably wherein the unit is assembled piecewise. Preferably, the unit is contained within a housing. In an embodiment, the housing is a shipping container or the like. In another embodiment, the interior of the shipping container has been adapted to receive a plurality of energy storage apparatus (i.e., plurality of graphite panels, where each energy storage apparatus is typically one graphite panel) as described herein. In one embodiment, the plurality of apparatus is arranged in series or parallel. In certain embodiments, the energy storage array comprises two, three, four, five, six, seven, eight, nine or ten energy storage apparatus. In certain embodiments, the energy storage array comprises at least two, at least three, at least four, at least five, at least six, at least seven, at least eight, at least nine or at least ten energy storage apparatus. In a preferred embodiment, a 20-foot shipping container houses two or three graphite panels.

### Method of Regulating Outlet Temperature

In some embodiments, it may be advantageous to regulate the outlet temperature of the energy storage apparatus as described herein to suit an industrial or commercial process that uses the heat transfer medium requiring a fixed temperature input, potentially at variable pressures and flow rates. In these embodiments, attemperation can be used to regulate the outlet temperature of the thermal energy storage apparatus (or energy storage array) by mixing the outlet stream of the thermal energy storage apparatus with a cooling stream to provide a desired temperature for these processes.

In certain embodiments, the method of reversibly storing and/or extracting energy further comprises a step of regulating the outlet temperature of the heat transfer medium to provide a regulated outlet temperature.

Advantageously, the regulating step may be performed in multiple stages. For example, the regulating step may be performed by a combination of a first-stage (or “coarse”) attemperation and a second-stage (or “fine”) attemperation. This multi-stage approach allows the use of less exotic materials and components (e.g., controls, valves) to fulfil the outlet temperature regulation. This is because the first-stage attemperation can reduce the outlet temperature to below a threshold temperature such that the heat exchanger downstream of the first-stage attemperation can use conventional materials which reduces cost of the materials. In these embodiments, the first-stage attemperation is positioned as close as possible to the thermal energy storage apparatus. The multistage attemperation can be adapted to use varying outlet temperature, flow rates and/or pressure.

In some embodiments, the step of regulating the outlet temperature comprises mixing the heat transfer medium and a stream of cooling liquid having a temperature below an initial outlet temperature in an attemperation unit comprising a first-stage mixing chamber and optionally a second-stage mixing chamber to provide the regulated outlet temperature. For example, the cooling liquid is water.

In some embodiments, the mixing in an attemperation unit is performed at a ratio of the heat transfer medium and the cooling liquid between about 20:1 to about 1:20, between about 15:1 to about 1:15, between about 10:1 to about 1:10, between about 5:1 to about 1:5, between about 2:1 to about 1:2, between about 15:1 to about 1:20, between about 10:1 to about 1:20, between about 5:1 to about 1:20, between about 2:1 to about 1:20, between about 20:1 to about 1:15, between about 20:1 to about 1:10, between about 20:1 to about 1:5, or between about 20:1 to about 1:2. In certain embodiments, the heat transfer medium is a liquid. In preferred embodiments, the mixing of heat transfer medium and cooling liquid is a liquid-to-liquid mix.

In some embodiments, the stream of cooling liquid is introduced to the attemperation unit through at least one flow valve. In some embodiments, the flow valve is a fixed flow valve or a variable flow valve.

In some embodiments, the stream of cooling liquid is introduced to the first-stage mixing chamber through at least one flow valve. In some embodiments, the stream of cooling liquid is introduced to the second-stage mixing chamber through at least one flow valve. In these embodiments, the flow valve is a fixed flow valve or a variable flow valve.

In some embodiments, the stream of cooling liquid is introduced to the attemperation unit by an atomiser, a nozzle or an injector. In some embodiments, wherein the stream of cooling liquid is introduced to the attemperation unit by an atomiser, a nozzle or an injector downstream of the at least one flow valve. In some embodiments, the stream of cooling liquid is introduced to the attemperation unit comprising the second-stage mixing chamber by an atomiser, a nozzle or an injector.

In some embodiments, the regulated outlet temperature is below a threshold temperature, wherein the threshold temperature is between 25% and 99%, between 25% and 90%, between 25% and 80%, between 25% and 70%, between 25% and 60% or between 25% and 50% of the initial outlet temperature. In certain embodiments, the method further comprises a step of reducing the regulated outlet temperature by mixing the heat transfer medium and the stream of cooling liquid in a second-stage mixing chamber to provide an application temperature.

In some embodiments, the mixing in the first-stage mixing chamber and/or second-stage mixing chamber is performed at a ratio of the heat transfer medium and the cooling liquid between about 20:1 to about 1:20, between about 15:1 to about 1:15, between about 10:1 to about 1:10, between about 5:1 to about 1:5, between about 2:1 to about 1:2, between about 15:1 to about 1:20, between about 10:1 to about 1:20, between about 5:1 to about 1:20, between about 2:1 to about 1:20, between about 20:1 to about 1:15, between about 20:1 to about 1:10, between about 20:1 to about 1:5, or between about 20:1 to about 1:2.

In some embodiments, the initial outlet temperature is between about 100° C. to about 800° C., between about 100° C. to about 700° C., between about 100° C. to about 600° C., between about 100° C. to about 400° C., between about 100° C. to about 200° C., between about 200° C. to about 800° C., between about 400° C. to about 800° C., or between about 600° C. to about 800° C.

In some embodiments, the threshold temperature (i.e., coarse attemperation) is between about 100° C. to about 500° C., between about 100° C. to about 400° C., between about 100° C. to about 300° C., between about 100° C. to about 200° C., between about 200° C. to about 500° C., between about 300° C. to about 500° C., or between about 400° C. to about 500° C. In one embodiment, the threshold temperature is about 400° C.

In some embodiments, the threshold temperature has a temperature fluctuation of between about ±50° C., between about ±40° C., between about ±30° C. or between about ±20° C.

In some embodiments, the application temperature (i.e., fine attemperation) is between about 100° C. to about 300° C., between about 100° C. to about 250° C., between about 100° C. to about 200° C., between about 100° C. to about 150° C., between about 150° C. to about 300° C., between about 200° C. to about 300° C., or between about 250° C. to about 300° C. In one embodiment, the application temperature is about 200° C.

In some embodiments, the application temperature has a temperature fluctuation of between about ±5° C., between about ±4° C., between about ±3° C. or between about ±2° C.

In some embodiments, the cooling liquid has a temperature of between about 20° C. to about 200° C., between about 20° C. to about 150° C., between about 20° C. to about 100° C., between about 20° C. to about 50° C., between about 50° C. to about 200° C., between about 100° C. to about 200° C., or between about 150° C. to about 200° C.

### Apparatus for Regulating Outlet Temperature

According to another aspect of the invention there is provided an energy storage apparatus comprising: a sensible heat storage body having a heat exchanger channel and a heating element channel adapted to receive a removable heating element, wherein the heating element channel is located internally of the sensible heat storage body; and a heat exchanger having an inlet and an outlet, wherein at least a portion of the heat exchanger is disposed along the channel; an attemperation unit comprising a first-stage mixing chamber and optionally a second mixing chamber, wherein the attemperation unit is in fluid communication with the outlet of the heat exchanger for regulating the outlet temperature of the heat transfer medium to provide a regulated outlet temperature.

In some embodiments, the attemperation unit is adapted to receive a stream of cooling liquid for regulating the outlet temperature of the heat transfer medium.

In some embodiments, the attemperation unit comprises at least one flow valve for introducing the stream of cooling liquid to the attemperation unit.

In some embodiments, the flow valve is a fixed flow valve or a variable flow valve.

In some embodiments, the attemperation unit comprises 1, 2, 3, 4, 5, 6, 7, 8, 9, 10, 11, 12, 13, 14, 15, 16, 17, 18, 19 or 20 fixed flow valves for introducing the stream of cooling liquid to the first-stage mixing chamber. In certain embodiments, the fixed flow valves have different fixed flow rates. The skilled person would appreciate that the fixed flow valves may be operated in any combination to provide a digital approximation of a variable flow valve. For example, 16 levels of flow control may be achieved from 4 fixed flow valves with different fixed flow rates.

In some embodiments, the flow valves share a common inlet and/or outlet manifold. This embodiment advantageously simplifies the implementation and reduces the cost.

In some embodiments, the attemperation unit comprises 1, 2, 3, 4, 5, 6, 7, 8, 9, 10, 11, 12, 13, 14, 15, 16, 17, 18, 19 or 20 variable flow valves for introducing the stream of cooling liquid to the second-stage mixing chamber. The skilled person would appreciate that this provides more flexibility for the second-stage attemperation.

In some embodiments, the attemperation unit comprises an atomiser, a nozzle or an injector for introducing the stream of cooling liquid to the attemperation unit.

In some embodiments, the first-stage mixing chamber is in fluid communication with the outlet of the heat exchanger to reduce the outlet temperature of the heat transfer medium to a regulated outlet temperature by mixing the heat transfer medium with a stream of cooling liquid having a temperature below an initial outlet temperature in the first-stage mixing chamber; and the attemperation unit further comprises a second-stage mixing chamber in fluid communication with the first mixing chamber to reduce the regulated outlet temperature to provide an application temperature by mixing the heat transfer medium and the stream of cooling liquid in the second-stage mixing chamber.

In some embodiments, wherein the first-stage mixing chamber is proximal to the outlet of the heat exchanger, and the second-stage mixing chamber is distal to the first-stage mixing chamber. Advantageously, this reduces the cost of downstream piping materials.

In certain embodiments, the first-stage mixing chamber is located within 5 m, 4 m, 3 m, 2 m, 1 m, 50 cm, 20 cm, 10 cm, 5 cm, or 1 cm of the outlet of the heat exchanger.

In certain embodiments, the second-stage mixing chamber is located more than 50 cm, 1 m, 2 m, 3 m, 4 m, 5 m, 6 m, 7 m, 8 m, 9 m, or 10 m of the outlet of the heat exchanger.

According to another aspect of the invention there is provided an energy storage array comprising a plurality of energy storage apparatus as described herein.

In some embodiments, the energy storage array comprises at least one second-stage mixing chamber in fluid communication with at least one of the first-stage mixing chambers for reducing the regulated outlet temperature of the heat transfer medium to provide an application temperature by mixing the heat transfer medium and a stream of cooling liquid in the second-stage mixing chamber.

In some embodiments, the first-stage mixing chamber is proximal to each outlet of the heat exchanger of the energy storage apparatus in the energy storage array, and the second-stage mixing chamber is distal to the first-stage mixing chamber in the energy storage array.

In some embodiments, each energy storage apparatus of the energy storage array comprises at least one first-stage mixing chamber in fluid communication with the outlet of the heat exchanger of each energy storage apparatus; and wherein the energy storage array comprise one second-stage mixing chamber in fluid communication with each first-stage mixing chambers. In certain embodiments, the second-stage mixing chamber is proximal to the industrial or commercial process to thereby reduce piping material costs.

The present invention can provide in certain embodiments at least one of the following advantages: (a) reduced heat loss and improved thermal efficiency as a result of direct contact between the removable heating element with the sensible heat storage body; (b) improved lifespan of the removable heating element as the electrical terminals are adequately cooled and/or thermally insulated and ingress of graphite powder when in contact with the sensible heat storage body is prevented; (c) reduced number of heating elements required for a target operating temperature as each heating element can use a higher watt density; (d) providing more uniform temperature profile during storage of thermal energy; (e) allows easier maintenance by replacing or repairing the removable heating elements as required; (f) lower heat loss by providing adequate insulation; (g) oxygen exclusion by providing inert gas and internal pressure management system when energy storage apparatus is enclosed; (h) prolonged discharge of energy when there is attemperation; (i) can eliminate or minimise the conditions required for a graphite fire; and (j) lower cost for operation and maintenance.

### DEFINITIONS

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”. The examples are not intended to limit the scope of the invention. In what follows, or where otherwise indicated, “%” will mean “weight %”, “ratio” will mean “weight ratio” and “parts” will mean “weight parts”.

The term ‘substantially’ as used herein shall mean comprising more than 50% by weight, where relevant, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

The prior art referred to herein is fully incorporated herein by reference.

Although exemplary embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

### BRIEF DESCRIPTION OF THE DRAWINGS

Preferred embodiments of the invention will now be described, by way of example only, with reference to the accompanying drawings in which:

FIG. 1 shows an embodiment of the energy storage apparatus of the present invention. a) side perspective view; b) cross-sectional perspective view taken along the line A-A of FIG. 1a; and c) cross-sectional perspective view taken along the line B-B of FIG. 1a without heat exchanger tubing and heating elements present.

FIG. 2 shows an embodiment of the energy storage apparatus of the present invention encased in an enclosure. a) side perspective view of front; and b) side perspective view of back.

FIG. 3a shows an embodiment of the heating element of the present invention. FIG. 3b shows an end view of the heating element of FIG. 3a in use when inserted into a heating element channel.

FIG. 4a shows an embodiment of the heating element of the present invention in use when inserted into an embodiment of the energy storage apparatus. FIG. 4b shows the opposite end of the heating element of FIG. 4a.

FIG. 5 shows an embodiment of the heating element mount pad of the present invention.

FIG. 6 shows an embodiment of a heat exchanger design in the form of a serpentine coil. a) side perspective view; and b) cross-sectional perspective view taken along the line A-A of FIG. 6a.

FIG. 7a shows an embodiment of a component of the enclosure having an aperture to receive the heat exchanger. FIG. 7b shows the assembly of a prior art embodiment of an over-pressure vent panel.

FIG. 8 shows an embodiment of the bellows sealing configuration for sealing engagement between the heat exchanger and the enclosure.

FIG. 9 shows attemperation of fluid outlet temperature.

FIG. 10a shows an embodiment of a manifold assembly for attemperation. FIG. 10b shows an embodiment of an energy storage unit comprising a 20 ft HC intermodal container.

FIGS. 11a-d shows schematics of different embodiments of using pressure regulators for an inert gas blanketing system. FIG. 11e shows an alternative pressure regulator using a water column.

FIG. 12 shows a process flow diagram for an embodiment (Test Rig 1) for an inert gas blanketing system.

FIG. 13 shows a process flow diagram to FIG. 12 for an embodiment (Test Rig 2) for an inert gas blanketing system. In this embodiment, a pilot operated back pressure regulator replaces the fabricated backpressure device of Test Rig 1.

FIG. 14 shows an alternative process flow diagram for an embodiment of an inert gas blanketing system of the present invention.

FIG. 15 shows an embodiment of an energy storage array comprising three energy storage apparatus, three first-stage mixing chambers and one second-stage mixing chamber, for regulating the outlet temperature.

FIG. 16 shows an embodiment of the first-stage attemperation.

FIG. 17 shows an embodiment of the second-stage attemperation.

FIG. 18 shows a comparison of outlet temperature with no attemperation, first-stage and second-stage attemperation.

### DETAILED DESCRIPTION OF THE INVENTION

The skilled addressee will understand that the invention comprises the embodiments and features disclosed herein as well as all combinations and/or permutations of the disclosed embodiments and features.

### EXAMPLES

### Example 1—Energy Storage Apparatus

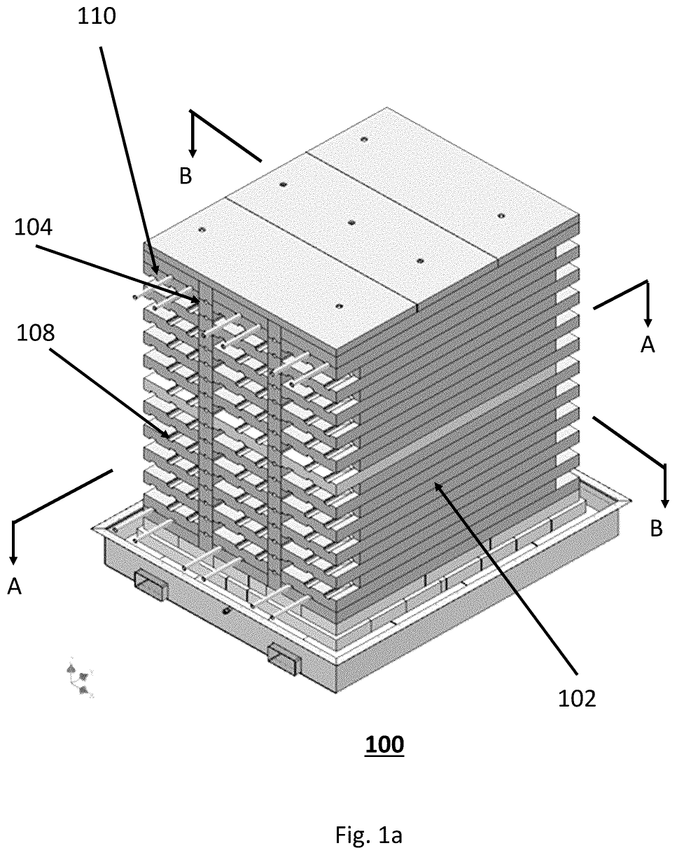

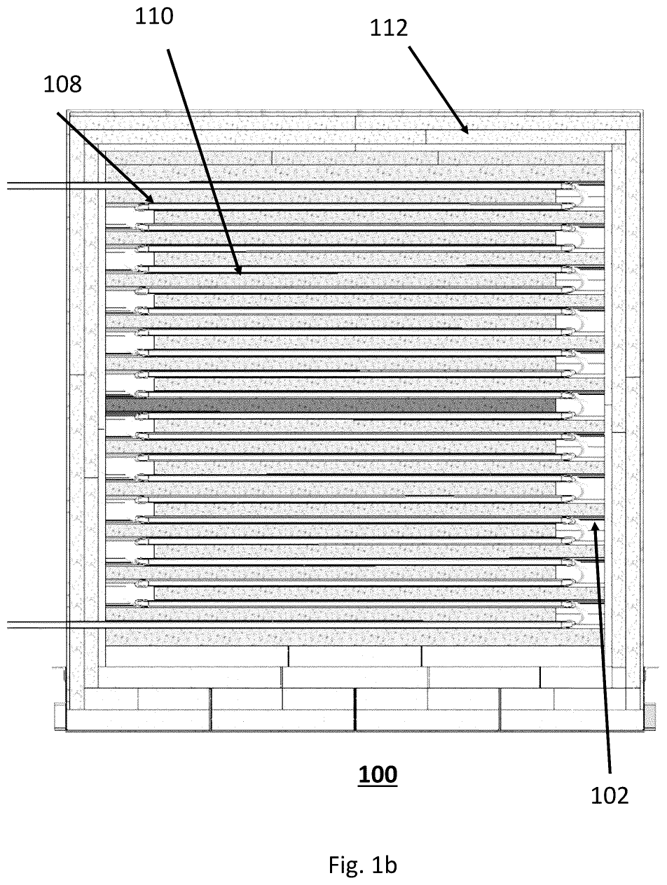

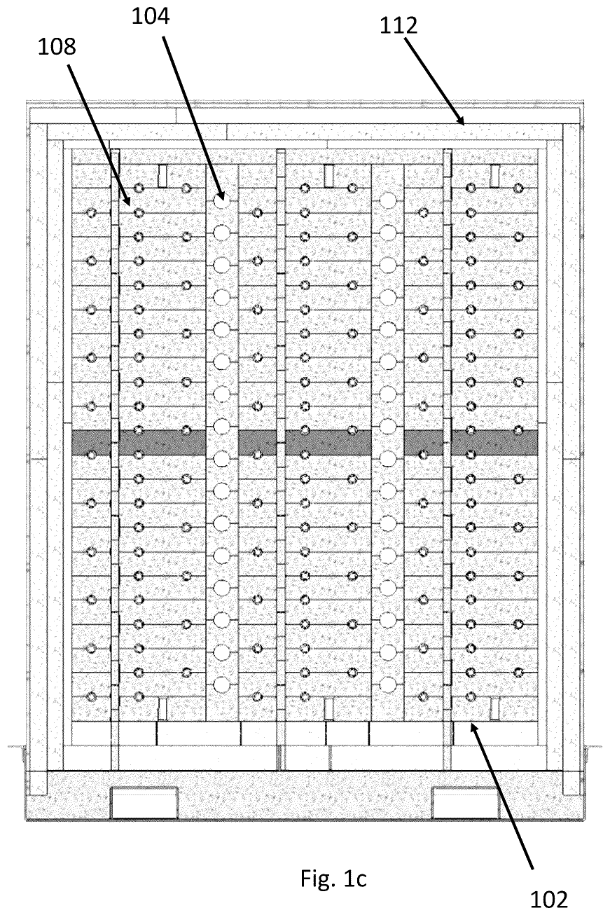

Referring to FIG. 1a, there is shown a sensible heat storage body 102 for use as an energy apparatus 100. The sensible heat storage body 102 has a heating element channel 104 for receiving a removable heating element 106 (not shown). The sensible heat storage body 102 also has a heat exchanger channel 108 for receiving the heat exchanger 110. The sensible heat storage body 102 is assembled by component parts and can be milled, machined or the like to provide the heating element channel 104 and heat exchanger channel 108 having at least two open ends within the sensible heat storage body. The sensible heat storage body 102 is in the form of a graphite panel comprised of component ‘slabs’ of graphite machined to snugly receive a heat exchanger 110 as well as a heating element 106.

Referring to FIGS. 1b-c, the energy storage apparatus 100 shows an embodiment comprising four layers of insulation 112. Each piece of insulation is layered in a staggered overlapping manner to minimise the amount of heat and hot gas leakage from the energy storage apparatus. As the temperature of each subsequent insulation layer 112 from the hot graphite body 102 reduces, lower temperature insulating material 112 can be used, optimising the performance/cost ratio. The energy storage apparatus is then enclosed by an enclosure 114 (not shown).

In use, the removable heating element 106 heats the inner region of the sensible heat storage body 102 and the heat exchanger 110 is encased within the heat exchanger channel 108 of the sensible heat storage body 102 such that a heat transfer medium can flow from the inlet to the outlet of the heat exchanger 110 through the body 102.

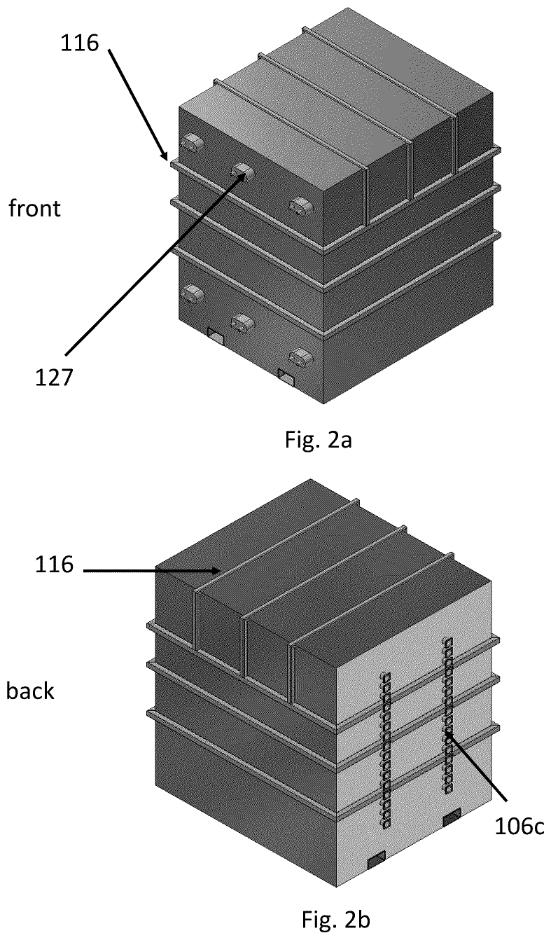

FIG. 2a-b shows the front and back view of the resulting encased energy storage apparatus 100 wherein the enclosure comprises structural reinforcement 116 such as in the form of a rib or case stiffener to increase the structural integrity of the enclosure to allow for greater internal pressures.

### Example 2—Heating Element

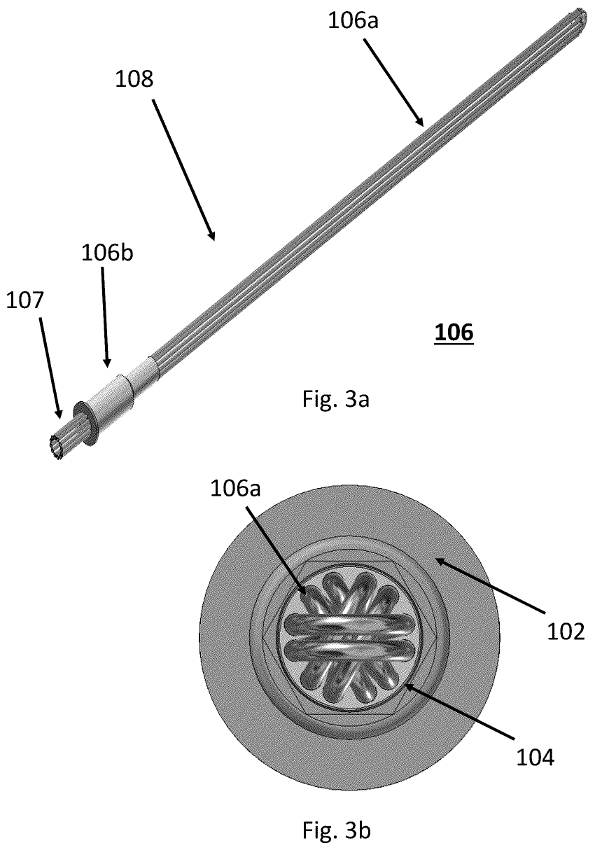

Referring to FIG. 3a, there is shown a heating element 106 having an elongated heating portion 106a at one end and a thermally insulated portion 106b at an opposite end. The thermally insulated portion has an electrical conductor (not shown) adapted to be in electrical communication with an electrical terminal 107. The thermally insulated portion 106b of the heating element 106 has two steps. The heating element is an electrical resistor wherein the heating portion 106a is in the form of tubular loops.

FIG. 3b shows an end view of the heating element 106 in use when inserted into the heating element channel 104. In use, the heating element 106 expands and contacts the surface of the inner region of the heating element channel 104. This allows for efficient conduction of the heat from the heater elements to the graphite body.

The heating element 106 comprises a resistance wire 106a, typically nichrome, surrounded by compacted magnesium oxide powder which is thermally conductive but electrically insulative. This is then encased in a heating element casing which is in the form of a sealed tubular metal sheath made from high temperature alloy material such as Inconel or Incoloy. Since graphite has low emissivity, high thermal conductivity and high specific heat which is the preferred material of the sensible heat storage body 102, the heating element 106 can be of high watt density, reducing the heating element surface area required and reducing the number of heating elements required and subsequent cost.

The heating element provides for easy removal and replacement of each heater from and into the energy storage apparatus.

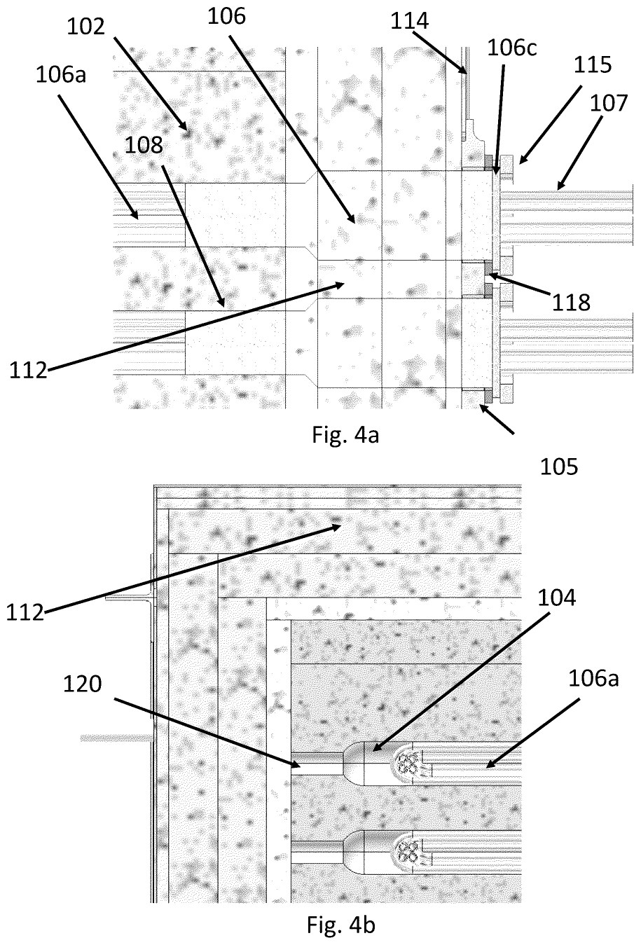

FIG. 4a shows insertion of the heating element 106 into the energy storage apparatus 102. The heating element 106 has a heating element flange 106c which is secured to the heating element mount pad 105 welded to the enclosure 114 using a clamping plate 115 and bolted. The heating element 106 has a length of ‘cold leg’ (thermally insulated portion 106b) where there is no resistance wire and only has a conducting wire/pin and this ‘cold leg’ section is thermally insulated. A portion of the length of the ‘cold leg’ is outside the enclosure 114 such that it is exposed to ambient temperatures to keep the electrical terminal 107 cool.

In alternative configurations, the heating element can be secured to the energy storage apparatus 100 by a tapered screw coupling for example.

A sealing gasket 118 can be provided between the clamping plate 115 and heating element mount pad 105 to provide a gas tight seal. Insulation 112 is provided similar to example 1 between the sensible heat storage body 102 and enclosure 114. This combination of features can ensure the electrical terminals 107 is adequately cooled by the surrounding air and thermally insulated to prolong the life of heating element 106 by reducing or preventing overheating of and hot gas migrating to the electrical terminals 107.

FIG. 4b shows the opposite end of the energy storage apparatus 100 where the heating element channel 104 of the sensible heat storage body further comprises a bore 120. The bore 120 is located opposite the opening of the heating element channel which receives the removable heating element 106. The bore 120 allows gas present in the heating element channel 104 to egress when heating the inner region of the sensible heat storage body during use by avoiding gas pressure build-up. This can avoid compromise of the gas tight seal due to overpressure. The bore 120 can also allow the heating element channel 104 to breathe out expanded gas (such as inert gas) when hot and breathe in gas when cooled. The heating element channel 104 also allows the longitudinal expansion of the heating element when heated.

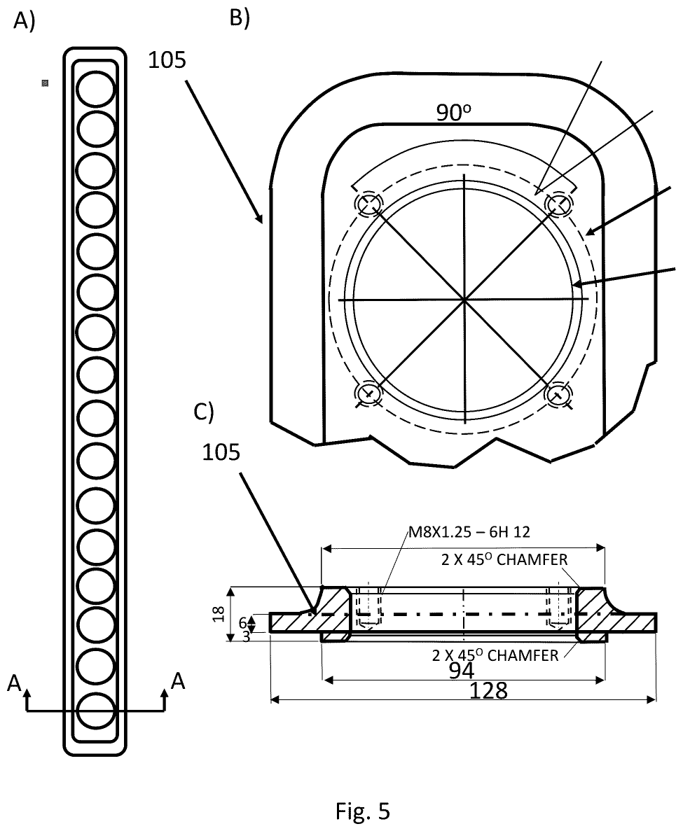

FIG. 5 shows an embodiment of the heating element mount pad 105. The heating element mount pad is a single piece with multiple apertures for receiving each individual heating element 106. The aperture of the heating element mount pad 105, aperture of the enclosure for receiving heating element 106 and diameter of the heating element channel 104 is larger than the thermally insulated portion of the heating element 106b diameter so that it can accommodate any misalignment from construction/assembly tolerances. The gasket bore is also larger than the chamfered step of the thermally insulated portion of the heating element 106b and compressed to seal the assembly using a clamping plate and bolts and washers. In this configuration, by removing the bolts, washers and clamping plate 115 allows each heater to be removed and replaced individually.

### Example 3—Heat Exchanger

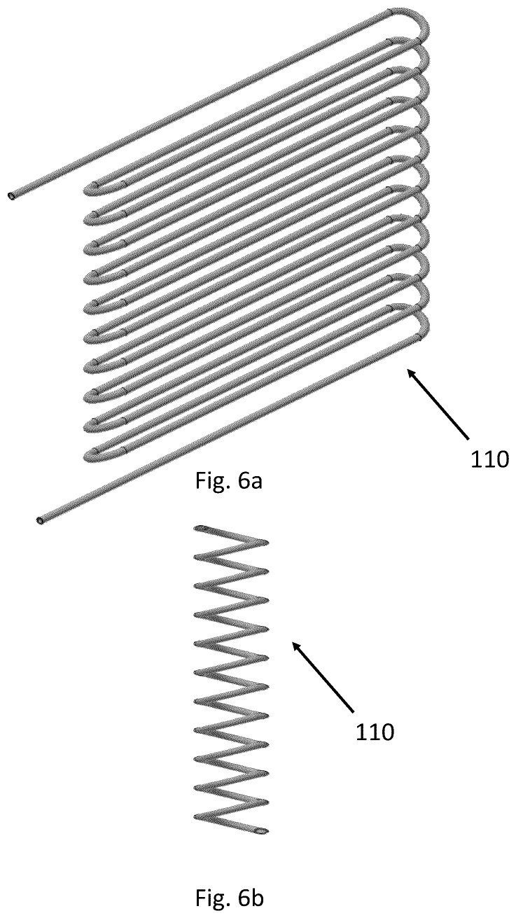

FIG. 6a-b shows an embodiment of a heat exchanger 110 design in the form of a serpentine coil. High tensile strength materials suitable for the heat exchanger 110 at elevated operating temperatures have reduced ductility and the bend radii needs to be larger than for typical highly ductile steel pipes for steam (HTF).

ASME B31.3 recommends a bend radius of 3D where D is the outside diameter of the pipe. For example, for a DN20 Sch 80 heat exchanger pipe, the bend radius would need to be 160 mm. For a 2 m high body of graphite as the sensible heat storage body, a vertical coil design (where alternating passes are in the same plane) provide about 12 horizontal runs per heat exchanger pipe encased in the graphite limiting the contact surface area of heat exchanger pipe in the graphite body.

In contrast, a rising serpentine heat exchanger coil design as shown in FIGS. 6a-b provides more flexibility in tailoring the contact area of heat exchanger pipe with the graphite body. For example, if the rise is about 50 mm (and assuming corresponding to an about 50 mm thick graphite slab component), a 160 mm bend radius can be achieved while having about 40 horizontal runs of pipe in a 2 m high graphite body. This is particularly significant as the extraction rate of thermal energy by the heat exchanger is 3 times that of a vertical coil design.

A further advantage to a serpentine coil heat exchanger design is that on heat extraction as the heat transfer fluid and/or working fluid flows through the heat exchanger conduit/pipes, heat in the graphite body transfers from left to right and from bottom to top, creating a more uniform temperature profile across the graphite body.

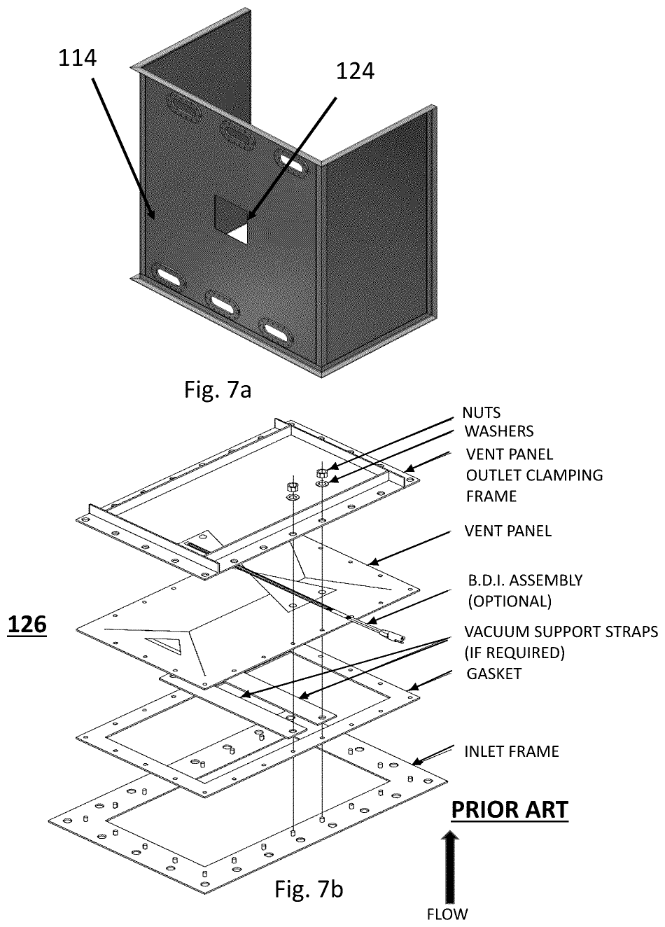

FIG. 7a shows a component of the enclosure 114 having an aperture to receive the heat exchanger 110 to be sealingly engaged using a bellows sealing configuration. The aperture of the enclosure 114 has a bellows sealing pad 122 for sealing engagement with the heat exchanger 110. A further over-pressure vent panel opening 124 is provided in the enclosure 114 in the event of over-pressure of inert gas within the enclosure 114 during operation. FIG. 7b shows the assembly of an embodiment of the over-pressure vent panel 126.

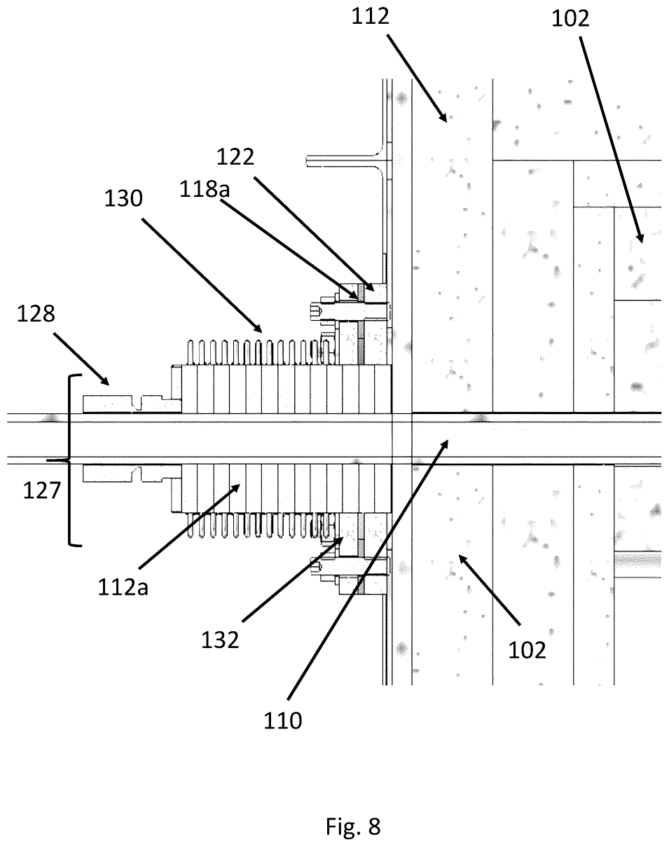

FIG. 8 shows the bellows sealing configuration for sealing engagement between the heat exchanger 110 and the enclosure 114. In this configuration, M10×50 mm SS grub screws screw entirely into the threaded holes of the sealing surfaces of the bellows sealing pad 122 which is welded to the enclosure 114. A sealing gasket 118a is inserted through the M10 grub screws and insulation discs 112a are threaded onto each heat exchanger pipe 110. A bellows sub-assembly 127 is placed over the insulation discs 112a and the heat exchanger pipe 110 through a tube connector. The bellows sub assembly 127 comprises the sealing gasket 118a, compression fitting 128, SS bellows ferrules or compression olive 130 and bellows flange 132. The compression olive or ferrules 132 is fitted over heat exchanger pipe 110 and compressed with the compression fitting 128.

When the heat exchanger 110 is sealingly engaged with the enclosure 114 of the energy storage apparatus 100, heat can be retained within the graphite body 102 and not leak via hot heat exchanger pipes 110 contacting the enclosure 114 because of the provision of a gas tight seal and thermal insulation.

### Example 4—Attemperation

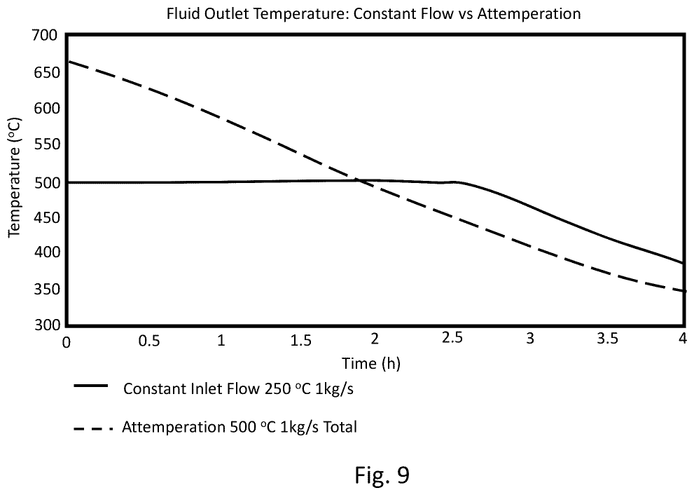

With sensible heat storage extraction, the discharge heat transfer fluid and/or working fluid temperature starts at the maximum storage temperature and reduces to the minimum operating temperature as the heat is extracted from the graphite body. In this configuration, a portion of the cooler inlet working fluid is mixed with the hotter outlet fluid maintaining a set temperature for a longer duration as shown in FIG. 9.

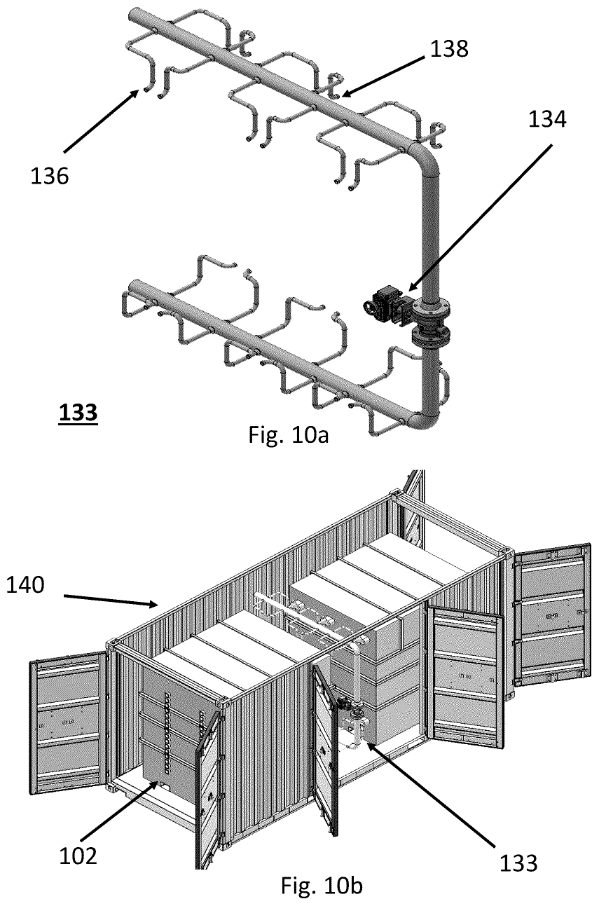

Attemperation can be provided by an embodiment as shown in FIG. 10a using a manifold assembly 133. A flow control valve 134 is disposed between the inlet manifold 136 and the outlet manifold 138. Temperature sensors (not shown) in the graphite body 102, inlet 136 and outlet manifolds 138 can determine the proportion of inlet manifold flow to be mixed with the outlet manifold flow of heat transfer fluid.

FIG. 10b shows a unit embodiment comprising a 20 ft HC intermodal container. Access to the housing 140 provide for insertion, removal and replacement of the tubular heating elements 106. Access to the housing can also provide for installation of the manifold assembly and service the flow control valve 134 which is disposed between two energy storage apparatus 100. The energy storage apparatus in the form of graphite panels 102 are secured within the container and the whole unit can be assembled and tested off site and transported to site.

The unit configuration of two, three or multiple graphite panels 102 can be stacked on top of each other to provide a high footprint storage density. A plurality of these graphite panels 102 are connected together with a manifold 133 and are housed in an intermodal container with standard openings to access the heating elements 106 and control valves 134. This design can provide for medium volume manufacture and ease of manufacturing and assembly off site and ease of transportation.

### Example 5—Inert Gas Blanketing

An energy storage apparatus of the present invention can be enclosed in an enclosure in an inert gas environment. Since the graphite panel is sealed ‘gas-tight’, increases in working/operating temperature will result in higher internal gas pressures. This pressure must be relieved to minimise the stresses caused by the panel enclosure expanding and contracting. Conversely, as the graphite panel cools the inert or surrounding gas will contract raising the possibility of vacuum being created, and the volume will need to be compensated.

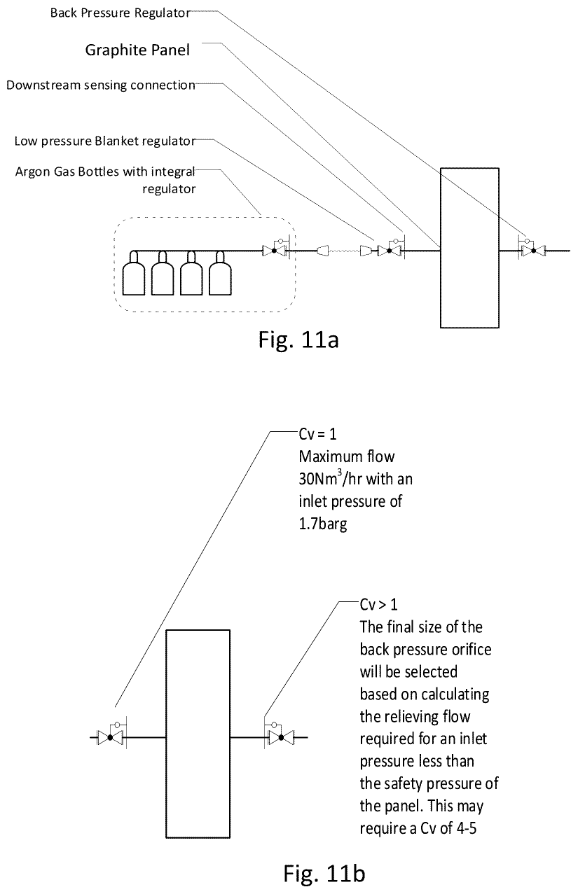

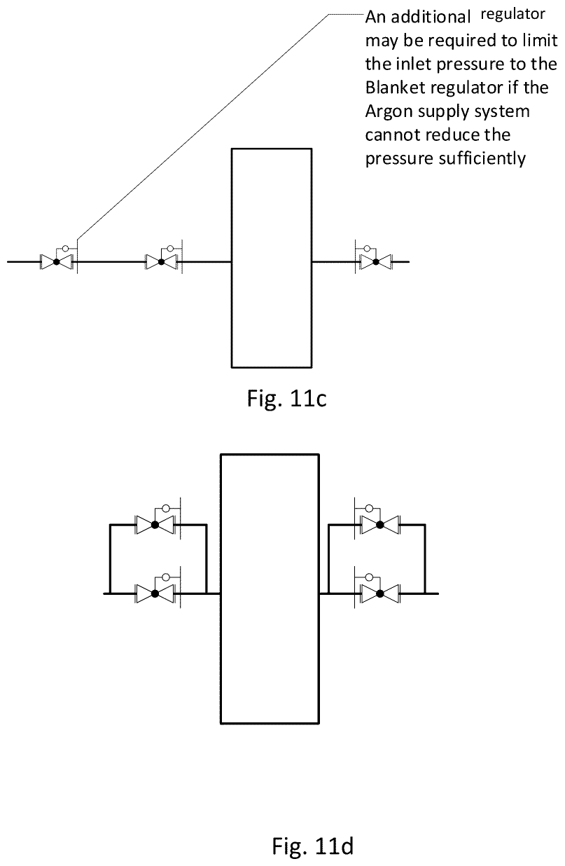

The purpose of the inert gas blanketing system is to provide an inert gas supply such as argon to the graphite panel and maintain the pressure at a minimum value, and to further relieve the argon should the pressure rise above a pre-set minimum as shown in FIG. 11a.

A pressure regulator can maintain pressure within the graphite panel. The pressure required is low and needs only to prevent the ingress of air. Blanket regulators are typically set at a few inches water column. In this system 1-2″ WC (˜2.5-5.0 mbar) is sufficient.

During the heating/storage phase, the internal pressure of the graphite panel will increase. The backpressure regulator will relieve the internal pressure to a predetermined value. The factors that influence the value of the backpressure setting include:

minimising the consumption of inert gas;

reducing the cycling stresses on the graphite panel enclosure; and

to provide sufficient margin between the normal operating pressure of the graphite panel and the burst pressure.

A value of 10″ WC (˜25 mbar) can be used in one embodiment. This could be increased if the burst pressure of the graphite panel is significantly higher (3-4 psi/200-300 mbar).

While the inert gas blanket system is required to prevent material degradation in the graphite panel, its failure could result in system damage or catastrophic failure of the graphite panels.

At least two components of a pressure regulator can fail which are the diaphragm and the spring. The consequence of a spring failure is for the pressure regulator to close, i.e. reduce the pressure and prevent the flow of inert gas. While this mode is suboptimal, it does not pose a significant risk of damage to the energy storage apparatus. Damage and failure can be mitigated by having another pressure regulator in parallel that will take over the supply of regulated inert gas.

The consequence of a diaphragm failure is that the regulator will not open. This failure mode causes the downstream pressure to increase and can have an extreme impact to the operation of the present invention if not mitigated.

The first level of mitigation can be installing a relief valve on the inert gas manifold set at a pressure setting which will not cause damage to the graphite panels. The second level of mitigation can be to ensure that the wide-open CV (the flow coefficient of a device and is a relative measure of its efficiency at allowing fluid flow) of the backpressure regulator is greater than the wide-open CV of the pressure regulator. This will prevent the accumulation of pressure in the graphite panel. A suitable pressure regulator can be one which has a minimum orifice CV of 1. Table 2 below shows the flow through the regulator in the wide-open (failure) condition.

TABLE 2
Different pressure regulator conditions for wide-open failure

| Inlet pressure | | | | CV = 1 | |
|---|---|---|---|---|---|
| Psig | bar | Kg/cm² | kPa | SCFH | Nm³/h |
| 25 | 1.7 | 1.76 | 172 | 1130 | 30.3 |
| 30 | 2.4 | 2.11 | 207 | 1280 | 34.3 |
| 40 | 2.8 | 2.81 | 276 | 1680 | 45.0 |
| 50 | 3.5 | 3.52 | 345 | 2050 | 54.9 |
| 60 | 4.1 | 4.22 | 414 | 2330 | 62.4 |
| 70 | 4.8 | 4.92 | 483 | 2670 | 71.6 |
| 80 | 5.5 | 4.92 | 483 | 2670 | 71.6 |
| 90 | 6.2 | 6.33 | 621 | 3410 | 91.4 |

If the backpressure regulator has a CV of greater than 1 (based on a calculation of maximum flow and a differential pressure referencing the safety pressure of the graphite panel), then there will be no accumulation of pressure in the panel. This system is shown in FIGS. 11b and 11c for example.

The failure modes for the backpressure regulator are the same as the pressure regulator; however, the consequences are different. A failure of the diaphragm will have the regulator wide open and causing it not to maintain pressure. This will result in a loss of inert gas, but not an accumulation of pressure. A failure of the spring, however, will result in the failed regulator to close and prevent it from relieving the pressure. The mitigation for this condition is to have a redundant back pressure regulator in parallel to the primary. The redundant regulator will take over control in the event of the failure of the primary as shown in FIG. 11d.

An alternative option of achieving backpressure to the storage panel is to connect the output line of the graphite panel to a water column as shown in FIG. 11e.

The principle of operation is based on the pressure effect of the weight of water. The pressure the base of the water column is equal to the height of water above it. If the height of the water were for example 10″, it would require an argon pressure greater than 10″ WC (˜25 mbar) for it to be relieved through the water column. In this configuration, the materials needed for this type of system are inexpensive as the system only encounters low pressure. For example, the water column type valve could be constructed from a thin-walled steel pipe or PVC piping.

The unit has a surge chamber above the water column. The purpose of this chamber is to prevent water from entering the graphite panel in the event of a rapid depressurising. The surge chamber has been nominally sized at twice the volume of liquid in the column.

Also, the liquid used does not need to be water. Other fluids, such as ethylene glycol could be used with the column height adjusted to account for the change in specific gravity. The disadvantage of using water is that biomaterial could accumulate, causing the unit to fail. Other liquids which do not support biomass development can address this issue. Also, these liquids can be are coloured which will aid inspection if a sight glass is installed in the column.

### (a) Test Rig 1

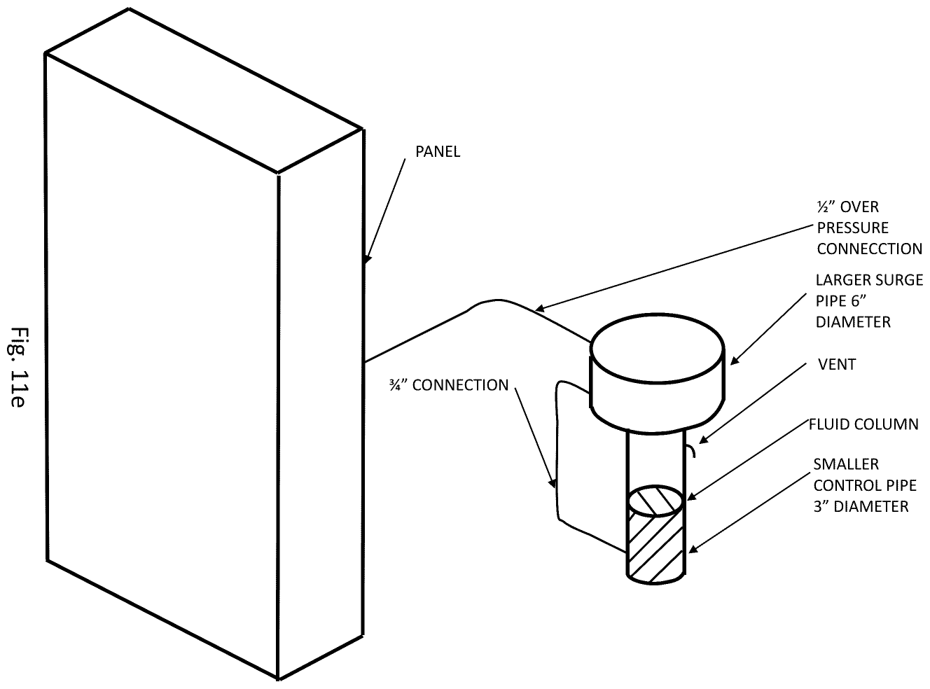

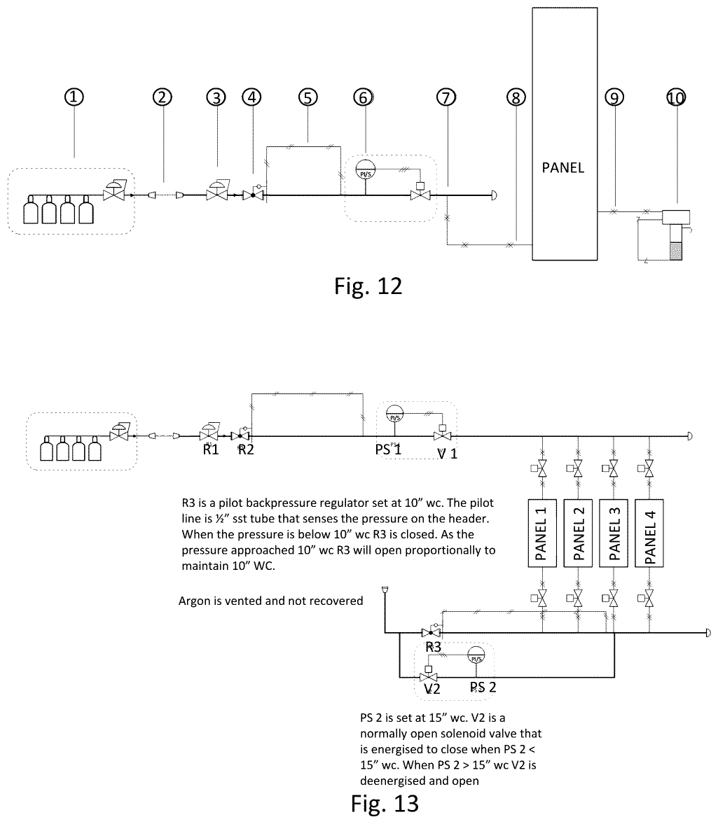

A test rig is shown in FIG. 12. In this embodiment, pressure needed to maintain a blanket of inert gas in the graphite panel is low, in the order of 1 to 2 inches water column (wcWC) (˜2.5-5.0 mbar).

The graphite panel is a sealed container that is heated. Since it is a sealed container, the pressure of the gas inside the container will increase when heated. To prevent an over pressure inside the graphite panel, a back-pressure regulator is installed that will relieve the gas if the pressure exceeds a predetermined pressure level. For this setup, a fabricated pressure maintaining device will be used in place of a backpressure regulator to carry out that function. The relieving pressure of the regulator should be set sufficiently high so not to relieve the inert gas unnecessarily, but at a point that will not stress the graphite panel enclosure during the heating and cooling cycles. In this configuration, the backpressure is assumed to be 10″ WC (˜25 mbar).

Argon is supplied in high-pressure bottles with an integrated pressure regulator to reduce the pressure (1). The argon bottles are connected to the argon header line by a flexible hose connection (2). The pilot regulator requires a maximum upstream pressure of 10 barg. If the bottle regulator cannot provide this pressure, a separate regulator (3) should be installed upstream of the pilot regulator to reduce the pressure to 10 barg (or lower). The accuracy of this regulator is not critical, as the pilot regulator will maintain an accurate downstream pressure regardless of the upstream pressure.

The pressure to the graphite panel is maintained by a low-pressure pilot operated regulator (4) set at 2″WC (˜5.0 mbar). The regulators pilot is connected to a downstream point with ½″ SST tubing (5). The location of the connection is not critical but should be sufficiently downstream so it is not affected by the turbulent flow from the pilot regulator output, and is sufficiently close to the inert gas inlet to ensure that the pressure regulation reflects the pressure of inert gas in the graphite panel.

A pressure switch and solenoid (6) is installed downstream of the pilot regulator to cut off the supply of inert gas to the graphite panel in the event of an overpressure (most likely caused by a regulator failure). The pressure switch setting should be above the backpressure setting and below the safety margin (pressure) of the graphite panel. In this instance, it is assumed to be 15″WC (˜37 mbar). The solenoid is energised to open, with a high-pressure signal de-energising the solenoid valve. Since the capacity (CV) of the backpressure device is much larger than the CV of the pilot pressure regulator, the likelihood of pressure increase in the graphite panel caused by a failure of the pilot regulator is low.

The connection of the inert gas from the inert gas header to the graphite panel, and from the graphite panel to the backpressure device is by a ¼″ SST tube (7) (8) (9). The size of the table is sufficient to pass the require volume of inert gas.

### (b) Test Rig 2

This system as shown in FIG. 13 replaces the fabricated backpressure device with a pilot operated back pressure regulator. If the regulator fails closed and the pressure rises. If it rises above the value of PS 2, valve V2 will open to vent the inert gas to the atmosphere.

(c) Principle of Operation—Process flow diagram (PFD)

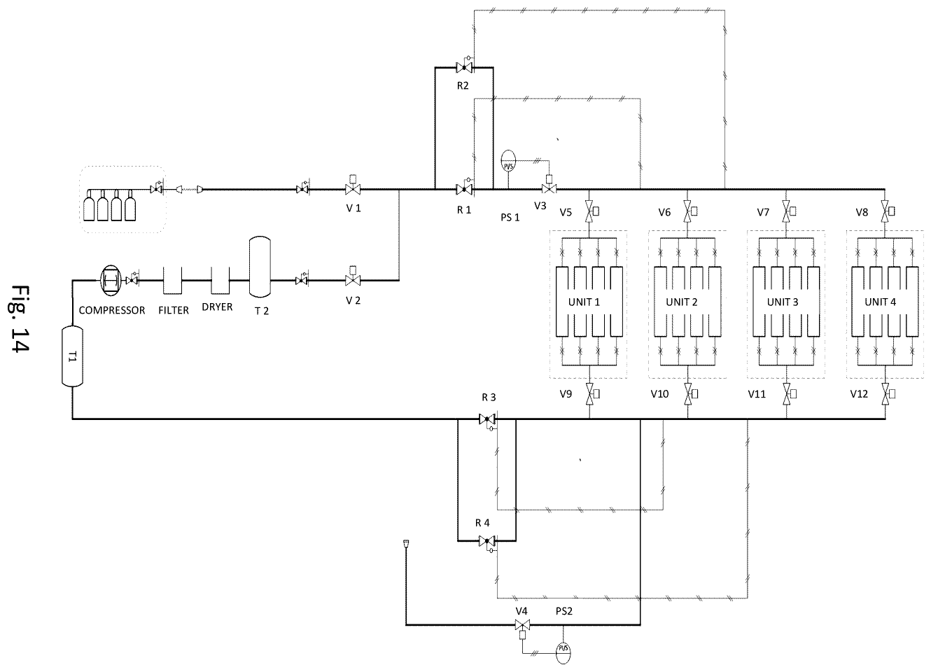

The PFD shown in FIG. 14 is a simplified PFD and omits non-return and manual isolation valves as well as instrumentation except for the pressure switches associated with manifold relief or inert gas isolation. The graphite panels are assembled into units. The PFD assumes that one unit contains four panels (number not essential to describe operation) and the energy storage array is shown with four units.

Inert gas such as argon to the graphite panels is supplied by the gas bottles or the recovered and compressed gas from the graphite panels. If there is leakage from the graphite panels while inert gas is supplied by recompression, the inert gas from the gas bottles will be blended with the recompressed inert gas to replace the lost inert gas. The method of detecting inert gas loss and combining bottled inert is not shown or described, however, would be known by persons skilled in the art.

Each unit can be isolated from the inert gas system if taken out of service. If isolated, both the inlet and outlet valves must be closed. In the case of Unit 1, this is V5 and V9.

There are two pressure reducing regulators in parallel to supply inert gas at a controlled pressure to the graphite panels. R1 is the primary regulator and set at 2″ WC and R2 is the secondary regulator set at 1″ WC.

If R1 fails in the closed configuration, the outlet pressure will fall. When it drops to 1″ WC, R2 will take over control.

If R1 or R2 fails in the open configuration, the pressure will rise. If the pressure increases above a predetermined value (PS 1), the solenoid valve V3 will close, and the flow of inert gas to the graphite panels will stop.

The pressure is maintained in the graphite panels by the backpressure regulators R3 (primary set at 10″ WC) and R4 (secondary set at 12″ WC). If R3 fails in the closed configuration, the pressure will rise. When it rises to 12″ WC, R4 will take over control.

If both R3 and R4 fail in the closed configuration, the pressure will rise. When it rises to a predetermined value (PS 2) V4 will open and vent inert gas to the atmosphere.

During normal operation, the inert gas outlet from R3 (or R4) is accumulated in T1. The inert gas is then compressed, filtered and dried and buffered in tank T2.

(d) Graphite Oxidation and Fire

The use of an inert gas blanketing system can avoid graphite oxidation which occurs in the presence of oxygen at temperatures above 450° C. Further, use of an inert gas blanketing system can prevent graphite fires. The four conditions which are all required for a graphite fire are:

High temperatures >1100° C.;

large mass of graphite;

exposure to adequate supply of oxygen; and

unchecked source of heat.

The energy storage apparatus of the present invention cannot trigger or sustain a graphite fire and each of these conditions have been designed to eliminate or reduce the risks.

Each heating element has a thermocouple welded to a sheath of the tubular element. This temperature is used to control the power input of the heater. Further, the heating element is designed to fail when sheath temperature reaches 1000° C.

The unit of the present invention has a maximum gross weight of 30 tonnes and each graphite panel is limited to 12 tonnes of graphite.

Each unit has an inert gas management system which monitors the oxygen level in the graphite panel with inert gas injection. The graphite body is encased in a gas tight enclosure and allowed to breath expelling hot inert gas and breathing in cool inert gas.

The operating temperature range of the energy storage apparatus is preferably from 500 to 800° C. (although variances to operating temperature out of this range is also possible depending on application), and when maximum set temperature is reached the power to the heating elements are cut off. The heater controls are fail-safe in that failure of the control system causes power to be cut off from the heating elements.

Further, heat can be extracted out of the graphite panels by flowing a heat transfer fluid and/or working fluid through the heat exchanger.

Example 6—Material Selection for sCO₂ Heat Exchanger Piping

The Applicant has evaluated 20 potential heat exchanger materials suitable for supercritical CO2 based on the following operating criteria:

Temperature between 500 to 800° C.;

Pressure from 100 to 250 bar (and above)

sCO₂ and air as heat transfer fluids; and

Heat exchanger piping embedded in solid graphite crucible.

In order to determine the suitability, each of the heat exchanger materials was evaluated and ranked with regards to their temperature/pressure performance, carburisation resistance, weldability, bendability, availability, cost, compatibility with sCO₂ and compatibility with molten aluminium. The materials shortlisted and ranked based on the above criteria (in descending order) are alloys 625, 740H, 230, 617 and 800HT. However, depending on application of the energy storage apparatus, the other heat exchanger materials may also be suitable for use in the energy storage apparatus of the present invention.

The following alloy materials are preferred:

625 is a preferred heat exchanger material due to its high ranking in most categories;

740H is another preferred heat exchanger material due to its high allowable stress at operating temperature;

230 remains in consideration as a substitute for 740H;

617; and

800HT remains in consideration for lower temperature and pressure applications, due to its low comparative cost and ready availability, this material is suitable if the temperature and pressure of the application are reduced and extent of carburisation can be quantified.

As would be appreciated by a person skilled in the art, the selection of a heat exchanger material can depend on the operating parameters of the energy storage apparatus. The preferred heat exchanger material can be application dependent due to factors such as operating conditions, project requirements and manufacturing environment. However, energy storage apparatus of the present invention is largely indifferent to heat exchanger material selection (i.e. only minor design changes are required for a different piping material).

To maximise energy conversion efficiency when the energy storage apparatus is used for supercritical fluids such as sCO2, the energy storage apparatus can be operated between 500 to 800° C. (and potentially above) and from 100 to 250 bar (and potentially above).

The heat exchanger piping is embedded in the solid graphite (assembled by component parts) and is used as the conduit for heat extraction, with sCO₂ and air considered for the heat transfer fluids (HTFs) at these high temperature and pressure conditions.

The energy storage apparatus of the present invention can be designed to comply with the following standards, ASME BPVC (relevant sections), ASME B31.3 and EU Pressure equipment Directive PED 2014/68/EU.

As the heat exchanger piping is in contact with graphite at high temperatures, the material is preferably carburisation resistant.

### Example 7—Regulating Outlet Temperature/Multistage Attemperation

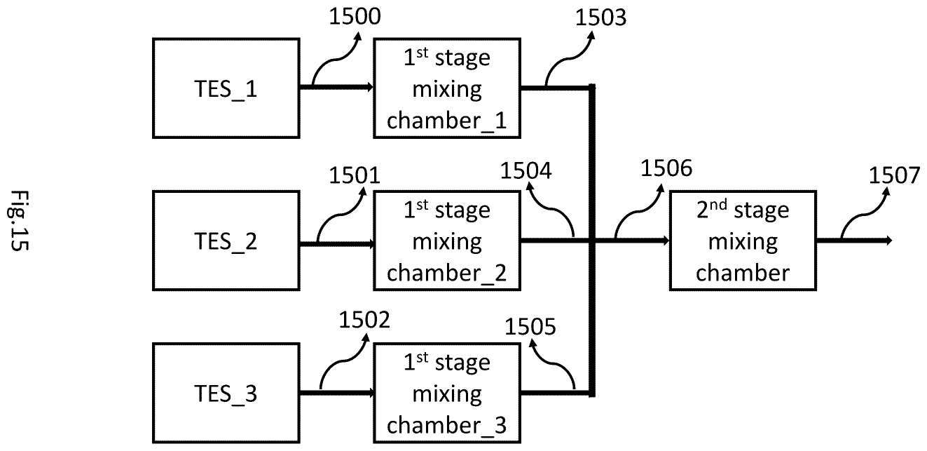

FIG. 15 shows an embodiment of an energy storage array comprising three energy storage apparatus (TES_1, TES_2, TES_3). Each energy storage apparatus is in fluid communication with a first-stage mixing chamber (first-stage mixing chamber_1, first-stage mixing chamber_2, first-stage mixing chamber_3), and a second-stage mixing chamber is in fluid communication with all the first-stage mixing chambers.

In operation, the three streams of heat transfer medium having an initial outlet temperature (1500, 1501, 1502) are mixed with a cooling liquid (not shown) in the first-stage mixing chambers to provide streams of heat transfer medium (1503, 1504, 1505) having a temperature below threshold temperature. These streams are then provided to a second-stage mixing chamber as a single stream (1506), where it is mixed with a cooling liquid to provide heat transfer medium stream (1507) at the application temperature. The skilled person would appreciate that the conditions of streams 1503, 1504 and 1505 are not necessarily the same and are dependent on the operating conditions including the temperature of the energy storage apparatus and the cooling liquid.

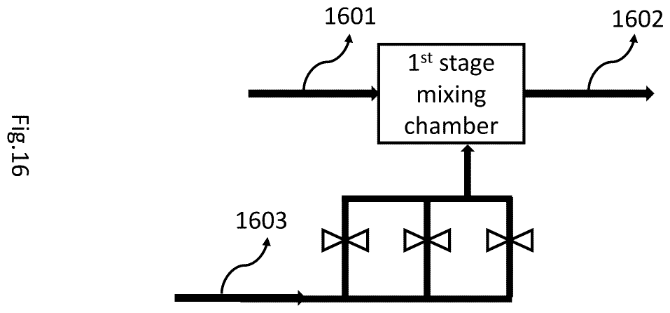

FIG. 16 shows an embodiment of the first-stage attemperation. An outlet stream (1601) from an energy storage apparatus is mixed with a cooling liquid stream (1603) in a first-stage mixing chamber to provide a stream of heat transfer medium (1602) with a temperature below a threshold temperature. The cooling liquid stream is introduced to the first-stage mixing chamber via three fixed flow valves. The valves may have different fixed flow rates to provide a total of 8 different levels of flow control.

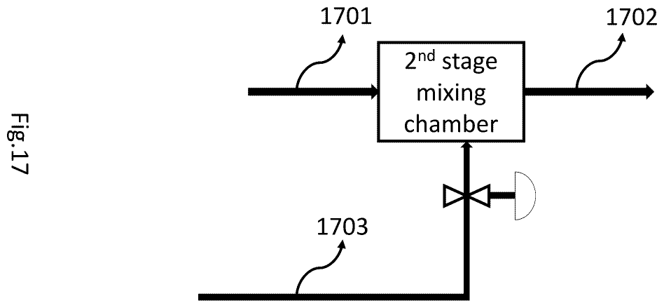

FIG. 17 shows an embodiment of the second-stage attemperation. A stream (1701) from a first-stage mixing chamber is mixed with a cooling liquid stream (1703) in a second-stage mixing chamber to provide a stream of heat transfer medium (1702) with a regulated temperature. The cooling liquid stream is introduced to the second-stage mixing chamber via a variable flow valve to allow fine tuning of the regulated temperature.

Table 3 shows nominal operating condition ranges of different streams shown in FIGS. 15 to 17.

TABLE 3
Nominal operating conditions

| | Temperature | Pressure | Flowrate |
|---|---|---|---|
| Stream | (° C.) | (kPa) | (kg/hr) |
| 1500, 1501, 1502 | 200-750 | 1400-1600 | 0-1000 |
| 1503, 1504, 1505 | 200-500 | 1400-1600 | 0-1000 |
| 1506 | 200-500 | 1400-1600 | 0-3000 |
| 1507 | 120-250 | 1400-1600 | 0-3000 |
| 1603, 1703 | 20-159 | 2400-2600 | 0-250 |

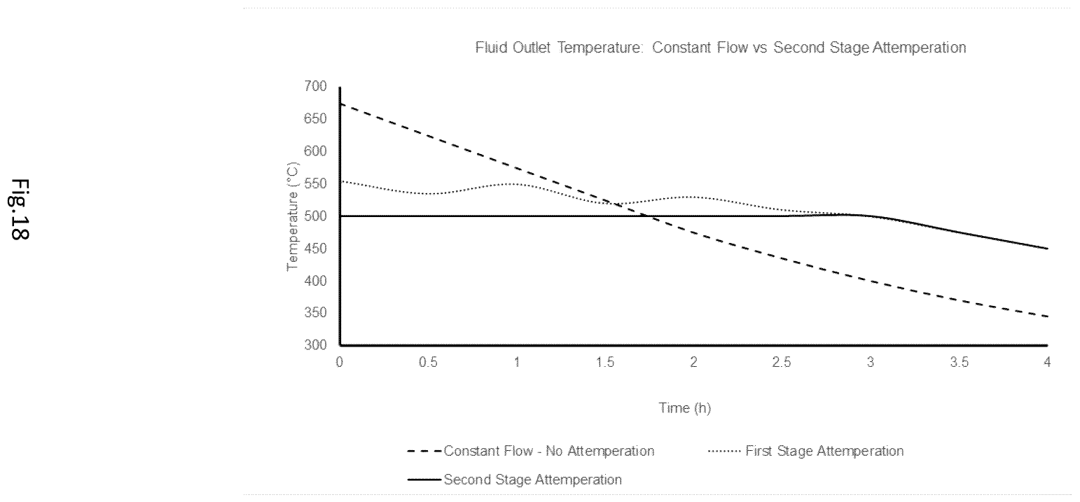

FIG. 18 shows a comparison of outlet temperature with no attemperation, first-stage and second-stage attemperation.

Those skilled in the art will appreciate that the invention described herein is susceptible to variations and modifications other than those specifically described. It is understood that the invention includes all such variations and modifications which fall within the spirit and scope of the present invention.

1. A method of reversibly storing and/or extracting energy comprising the steps of:
heating an inner region of a sensible heat storage body using a removable heating element thereby storing energy, wherein a portion of the heating element is in contact with the inner region of the sensible heat storage body;
extracting energy by flowing a heat transfer medium through an inlet and an outlet of the sensible heat storage body having an inlet temperature below that of said sensible heat storage body such that energy is transferred from the sensible heat storage body to the heat transfer medium having an outlet temperature,
thereby providing reversible energy storage and extraction.

2. A method according to claim 1, further comprising a step of regulating the outlet temperature of the heat transfer medium to provide a regulated outlet temperature.

3. A method according to claim 2, wherein the step of regulating the outlet temperature comprises mixing the heat transfer medium and a stream of cooling liquid having a temperature below an initial outlet temperature in an attemperation unit comprising a first-stage mixing chamber and optionally a second-stage mixing chamber to provide the regulated outlet temperature.

4. A method according to claim 3, wherein the mixing is performed at a ratio of the heat transfer medium and the cooling liquid between about 20:1 to 1:20.

5. A method according to claim 3, wherein the stream of cooling liquid is introduced to the attemperation unit through at least one flow valve.

6. A method according to claim 4, wherein the flow valve is a fixed flow valve or a variable flow valve.

7. A method according to claim 3, wherein the stream of cooling liquid is introduced to the attemperation unit by an atomiser, a nozzle or an injector.

8. A method according to claim 5, wherein the stream of cooling liquid is introduced to the attemperation unit by an atomiser, a nozzle or an injector downstream of the at least one flow valve.

9. A method according to claim 3, wherein the regulated outlet temperature is below a threshold temperature, wherein the threshold temperature is between 25% and 99% of the initial outlet temperature.

10. A method according to claim 9, further comprising the step of:
reducing the regulated outlet temperature by mixing the heat transfer medium and the stream of cooling liquid in a second-stage mixing chamber to provide an application temperature.

11. A method according to claim 10, wherein the stream of cooling liquid is introduced to the second-stage mixing chamber through at least one flow valve. 12 A method according to claim 11, wherein the mixing is performed at a ratio of the heat transfer medium and the cooling liquid between about 20:1 to 1:20.

13. A method according to claim 11, wherein the flow valve is a fixed flow valve or a variable flow valve.

14. A method according to claim 11, wherein the stream of cooling liquid is introduced to the attemperation unit comprising the second-stage mixing chamber by an atomiser, a nozzle or an injector.

15. An energy storage apparatus comprising:
a sensible heat storage body having a heat exchanger channel and a heating element channel adapted to receive a removable heating element, wherein the heating element channel is located internally of the sensible heat storage body; and
a heat exchanger having an inlet and an outlet, wherein at least a portion of the heat exchanger is disposed along the channel;
an attemperation unit comprising a first-stage mixing chamber and optionally a second mixing chamber, wherein the attemperation unit is in fluid communication with the outlet of the heat exchanger for regulating the outlet temperature of the heat transfer medium to provide a regulated outlet temperature.

16. An energy storage apparatus according to claim 15, wherein the attemperation unit is adapted to receive a stream of cooling liquid for regulating the outlet temperature of the heat transfer medium.

17. An energy storage apparatus according to claim 16, wherein the attemperation unit comprises at least one flow valve for introducing the stream of cooling liquid to the attemperation unit.

18. An energy storage apparatus according to claim 17, wherein the flow valve is a fixed flow valve or a variable flow valve.

19. An energy storage apparatus according to claim 16, wherein the attemperation unit comprises an atomiser, a nozzle or an injector for introducing the stream of cooling liquid to the attemperation unit.

20. An energy storage apparatus according to claim 16, wherein the first-stage mixing chamber is in fluid communication with the outlet of the heat exchanger to reduce the outlet temperature of the heat transfer medium to a regulated outlet temperature by mixing the heat transfer medium with a stream of cooling liquid having a temperature below an initial outlet temperature in the first-stage mixing chamber; and
further comprising a second-stage mixing chamber in fluid communication with the first mixing chamber to reduce the regulated outlet temperature to provide an application temperature by mixing the heat transfer medium and the stream of cooling liquid in the second-stage mixing chamber.

21. An energy storage apparatus according to claim 20, wherein the first-stage mixing chamber is proximal to the outlet of the heat exchanger, and the second-stage mixing chamber is distal to the first-stage mixing chamber.

22. An energy storage array comprising: a plurality of energy storage apparatus according to claim 15.

23. An energy storage array according to claim 22,
wherein the energy storage array comprises at least one second-stage mixing chamber in fluid communication with at least one of the first-stage mixing chambers for reducing the regulated outlet temperature of the heat transfer medium to provide an application temperature by mixing the heat transfer medium and a stream of cooling liquid in the second-stage mixing chamber.

24. An energy storage array according to claim 23,
wherein the first-stage mixing chamber is proximal to the outlet of the heat exchanger, and the second-stage mixing chamber is distal to the first-stage mixing chamber.

25. An energy storage array according to claim 24, wherein each energy storage apparatus comprises at least one first-stage mixing chamber in fluid communication with the outlet of the heat exchanger of each energy storage apparatus; and wherein the energy storage array comprise one second-stage mixing chamber in fluid communication with each first-stage mixing chambers.
